(19) United States
(12) Patent Application Publication
(10) Pub. No.: US 2022/0198417 A1
(43) Pub. Date: Jun. 23, 2022

(54) REAL-TIME GENERATION AND PROVISIONING OF TARGETED PRODUCT DATA BASED ON STRUCTURED MESSAGING DATA

(71) Applicant: The Toronto-Dominion Bank, Toronto (CA)

(72) Inventors: Christopher Mark JONES, Villanova, PA (US); Barry Wayne Baird, JR., Kennett Square, PA (US); Claude Bernell Lawrence, JR., Philadelphia, PA (US); Jonathan Joseph Prendergast, West Chester, PA (US)

(21) Appl. No.: 17/554,160

(22) Filed: Dec. 17, 2021

Related U.S. Application Data
(60) Provisional application No. 63/128,031, filed on Dec. 19, 2020.

(51) Int. Cl. G06Q 20/12; G06Q 20/08; G06Q 20/40

(52) U.S. Cl. CPC G06Q 20/12; G06Q 20/401; G06Q 20/085

(57) ABSTRACT

The disclosed embodiments include computer-implemented systems and processes that generate and provision, in real time, targeted product data based on structured messaging data. For example, an apparatus receives message associated with an exchange of data involving a first counterparty and a second counterparty. The message may include elements of message data disposed within corresponding message fields, and characterizing a real-time payment requested from the second counterparty by the first counterparty. The apparatus may determine that a product is available to the second counterparty based on one or more of the elements of the message data, and may transmit notification data to a device operable by the second counterparty. The notification data comprising product data characterizing the product, and the first notification data causing an application program executed at the device to present at least a portion of the product data within a digital interface.

### CROSS-REFERENCE TO RELATED APPLICATION

This application claims the benefit of priority to U.S. Provisional Patent Application No. 63/128,031, filed on Dec. 19, 2020, the entire disclosure of which is expressly incorporated herein by reference to its entirety.

### TECHNICAL FIELD

The disclosed embodiments generally relate to computer-implemented systems and processes that generate and provision, in real time, targeted product data based on structured messaging data.

### BACKGROUND

The mass adoption of smart phones and digital payments within the global marketplace drives an increasingly rapid adoption of real-time payment (RTP) technologies by financial institutions, consumers, vendors and merchants, and other participants in the payment ecosystem. RTP technologies often emphasize data, messaging, and global interoperability and in contrast to many payment rails, such as those that support credit card payments, embrace the near ubiquity of mobile technologies in daily life to provide, to the participants in the RTP ecosystem, real-time service and access to funds.

### SUMMARY

In some examples, an apparatus includes a communications interface, a memory storing instructions, and at least one processor coupled to the communications interface and to the memory. The at least one processor is configured to execute the instructions to receive, via the communications interface, a message associated with an exchange of data involving a first counterparty and a second counterparty. The message includes elements of message data disposed within corresponding message fields, and the message data characterizes a real-time payment requested from the second counterparty by the first counterparty. The at least one processor is configured to execute the instructions to determine that a product is available to the second counterparty based on one or more of the elements of the message data. The product is associated with a first parameter value that is consistent with at least one second parameter value of the data exchange. The at least one processor is configured to execute the instructions to transmit, via the communications interface, first notification data to a device operable by the second counterparty. The first notification data includes product data characterizing the product, and the first notification data causes an application program executed at the device to present at least a portion of the product data within a digital interface.

In other examples, a computer-implemented method includes receiving, using at least one processor, a message associated with an exchange of data involving a first counterparty and a second counterparty. The message includes elements of message data disposed within corresponding message fields, and the message data characterizes a real-time payment requested from the second counterparty by the first counterparty. The computer-implemented method also includes determining, using the at least one processor, that a product is available to the second counterparty based on one or more of the elements of the message data. The product is associated with a first parameter value that is consistent with at least one second parameter value of the data exchange. The computer-implemented method includes transmitting, using the at least one processor, first notification data to a device operable by the second counterparty. The first notification data includes product data characterizing the product, and the first notification data causes an application program executed at the device to present at least a portion of the product data within a digital interface.

Further, in some examples, a tangible, non-transitory computer-readable medium storing instructions that, when executed by at least one processor, cause the at least one processor to perform a method that includes receiving a message associated with an exchange of data involving a first counterparty and a second counterparty. The message includes elements of message data disposed within corresponding message fields, and the message data characterizes a real-time payment requested from the second counterparty by the first counterparty. The method also includes determining that a product is available to the second counterparty based on one or more of the elements of the message data. The product is associated with a first parameter value that is consistent with at least one second parameter value of the data exchange. The method includes transmitting first notification data to a device operable by the second counterparty. The first notification data includes product data characterizing the product, and the first notification data causes an application program executed at the device to present at least a portion of the product data within a digital interface.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a block diagram of an exemplary computing environment, in accordance with some exemplary embodiments.

FIG. 2A is a block diagram illustrating a portion of an exemplary computing environment, in accordance with some exemplary embodiments.

FIG. 2B illustrates portions of an exemplary request for payment (RFP), in accordance with some exemplary embodiments.

FIGS. 3, 4A, and 4B are block diagrams illustrating portions of an exemplary computing environment, in accordance with some exemplary embodiments.

FIGS. 5A, 5B, and 5C are flowcharts of exemplary processes for provisioning targeted alternative product data to customer devices based on structured messaging data, in accordance with some exemplary embodiments.

Like reference numbers and designations in the various drawings indicate like elements.

### DETAILED DESCRIPTION

Today, the mass adoption of smart phones and digital payments within the global marketplace drives an adoption of real-time payment (RTP) technologies by financial institutions, consumers, vendors and merchants, and other participants in the payment ecosystem. These RTP technologies often emphasize data, messaging, and global interoperability and in contrast to conventional payment rails, may embrace the near ubiquity of mobile technologies in daily life to provide, to the participants in the RTP ecosystem, real-time service and access to funds. To facilitate the strong emphasis on data, messaging, and global interoperability between financial institutions, many RTP technologies adopt, and exchange data formatted in accordance with, one or more standardized data-exchange protocols, such as the ISO 20022 standard for electronic data exchange between financial institutions.

For example, a customer of a financial institution may initiate a transaction to purchases one or more products or services from a merchant or retailer, either through in-person interaction at a physical location of the merchant or retailer, or through digital interactions with a computing system of the merchant (e.g., via a web page or other digital portal). In some instances, and to fund the initiated purchase transaction, the customer may provide the merchant with data characterizing a payment instrument, such as credit card account issued by the financial institution (e.g., via input provisioned to the web page or digital portal, or based on an interrogation of a physical payment card by point-of-sale terminal, etc.). The merchant computing system may perform operations that generate elements of messaging data that identify and characterize the merchant and the initiated purchase transaction, and that include portions of the data characterizing the payment instrument, and that submit the generated elements of messaging data to a transaction processing network or payment rail in accordance with a predetermined schedule, e.g., in batch form with other elements of messaging data at a predetermined time on a daily basis. In some instances, one or more computing systems of the transaction processing network or payment rail may perform operations that execute, clear, and settle the initiated purchase transaction involving the payment instrument within a predetermined temporal interval subsequent to the initiation of the purchase transaction, such as, but not limited to, forty-eight hours.

In other examples, the merchant and the financial institution of the customer may represent participants in the RTP ecosystem, and the merchant computing system (or a computing system associated with a financial institution of the merchant) may generate a message, e.g., a Request for Payment (RFP) message, that requests a real-time payment from the customer that funds the initiated purchase transaction, and may transmit that message to one or more computing systems of the financial institution of the customer, e.g., directly or through one or more intermediate systems associated with the RTP ecosystem, such as a clearinghouse system. The generated and transmitted RFP message may, for example, be formatted in accordance with the ISO 20022 data-exchange format, and may include message fields populated with information that includes, but is not limited to, information identifying the customer and the merchant, information characterizing the requested payment (e.g., a requested payment amount, a requested payment date, an identifier of an account selected by the customer to fund the requested, real-time payment, or an identifier of an account of the merchant capable of receiving the requested, real-time payment, etc.) and information characterizing the initiated purchase transaction (e.g., a transaction date or time, or an identifier of one or more of the products or services involved in the initiated purchase transaction, such as a corresponding UPC, etc.). Further, the ISO-20022-compliant RFP message may also include a link within a structured or unstructured message field to information, such as remittance data, associated with the requested, real-time payment (e.g., a long- or shortened Uniform Resource Location (URL) pointing to a formatted invoice or statement that includes any of the information described herein).

In some examples, the elements of structured or unstructured data maintained within the message fields of exemplary, ISO-20022-compliant RFP messages described herein may extend beyond the often-limited content of the message data transmitted across many existing payment rails and transaction processing networks. Further, when intercepted and decomposed by a computing system of the financial institution of the customer (e.g., an FI computing system), these elements of structured or unstructured RFP message data may be processed by the FI computing system to determine adaptively terms and conditions of a financial product that is available for issuance to the customer by the financial institution, and that is available and appropriate to fund the real-time payment requested from the customer by the merchant and to provision, to a device of the customer in real-time and contemporaneously with the receipt of the RFP message, elements of digital content that prompt the customer to accept, or alternatively, decline an offer to fund the requested, real-time payment using the available financial product in accordance with the terms and conditions. By way of example, and using any of the exemplary processes described herein, the FI computing system may provision, to the customer device, a product notification that identifies and characterizes the available financial product, such as an installment loan, and the terms and conditions associated with that available financial product, and an application program executed by the customer device may perform operations, described herein, that render the product notification for presentation with a portion of a digital interface.

Upon presentation within the digital interface of the customer device, the product notification may, among other things, identify the available financial product and the determined terms and conditions, and may prompt the customer to accept, or alternatively decline, the offer to fund the requested, real-time payment the available financial product in accordance with the determine terms and conditions. Further, and based on confirmation data indicative of the customer acceptance of the offered financial product, the FI computing system may perform any of the exemplary processes described herein to issue the now-accepted financial product to the customer, and to generate an additional, ISO-2002-compliant RTP message, when provisioned to one or more computing systems of the merchant (or to an intermediate computing system, such as a computing system of the merchant's financial institution), provides the requested payment using funds drawn from the issued financial product in real-time and contemporaneously with the initiation of the purchase transaction and the requested for the payment by the merchant.

Certain of the exemplary processes described herein, which decompose the structured message fields of an ISO-20022-compliant RFP message to obtain elements of decomposed message data characterizing the customer, the merchant, the initiated purchase transaction, and the requested, real-time payment, which analyze the elements of decompose message data to determine terms and conditions of a financial product appropriate to, and available to fund, the requested, real-time payment, and which provision data characterizing the offer to fund, the requested, real-time payment using the available financial product to the customer device for presentation within a digital interface in real-time and contemporaneously with the initiated purchase transaction, may be implemented in addition to, or as an alternate to, many processes that relay on the often-limited content of temporally delayed message data transmitted across many existing payment rails and transaction processing networks.

### A. Exemplary Computing Environments

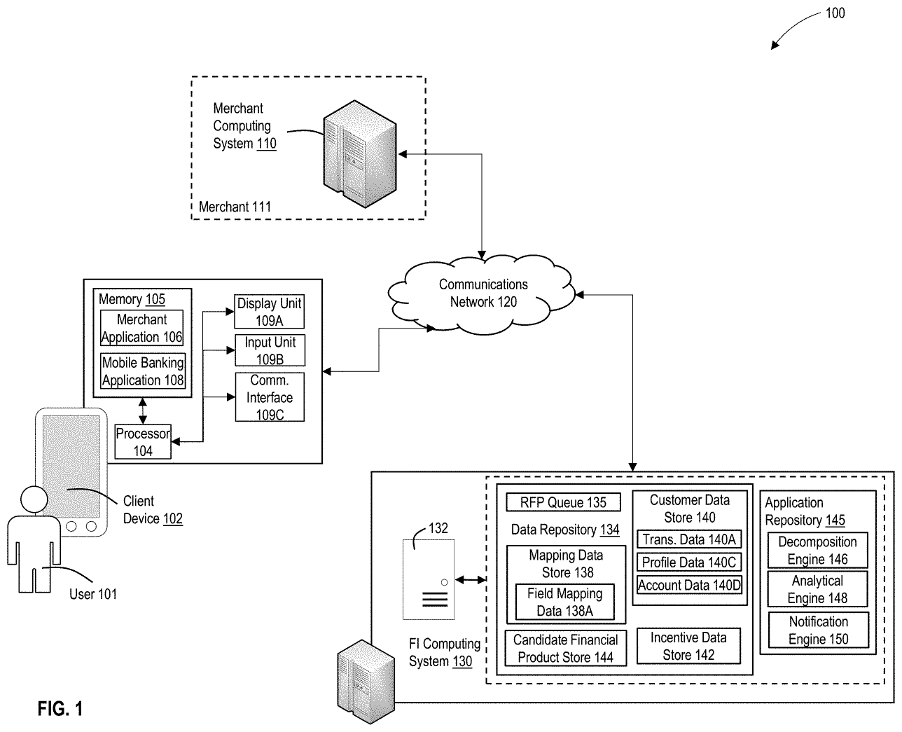

FIG. 1 is a diagram illustrating an exemplary computing environment 100 that includes, among other things, one or more computing devices, such as a client device 102, and one or more computing systems, such as a merchant computing system 110 and a financial institution (FI) system 130, each of which may be operatively connected to, and interconnected across, one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

Client device 102 may include a computing device having one or more tangible, non-transitory memories, such as memory 105, that store data and/or software instructions, and one or more processors, e.g., processor 104, configured to execute the software instructions. The one or more tangible, non-transitory memories may, in some aspects, store software applications, application modules, and other elements of code executable by the one or more processors, such as, but not limited to, an executable web browser (e.g., Google Chrome™, Apple Safari™, etc.), an executable application associated with merchant computing system 110 (e.g., merchant application 106), and additionally or alternatively, an executable application associated with FI computing system 130 (e.g., mobile banking application 108).

In some instances, not illustrated in FIG. 1, memory 105 may also include one or more structured or unstructured data repositories or databases, and client device 102 may maintain one or more elements of device data and location data within the one or more structured or unstructured data repositories or databases. For example, the elements of device data may uniquely identify client device 102 within computing environment 100, and may include, but are not limited to, an Internet Protocol (IP) address assigned to client device 102 or a media access control (MAC) layer assigned to client device 102.

Client device 102 may also include a display unit 109A configured to present interface elements to a corresponding user, such as a user 101, and an input unit 109B configured to receive input from user 101, e.g., in response to the interface elements presented through display unit 109A. By way of example, display unit 109A may include, but is not limited to, an LCD display unit or other appropriate type of display unit, and input unit 109B may include, but is not limited to, a keypad, keyboard, touchscreen, voice activated control technologies, or appropriate type of input unit. Further, in additional aspects (not illustrated in FIG. 1), the functionalities of display unit 109A and input unit 109B may be combined into a single device, e.g., a pressure-sensitive touchscreen display unit that presents interface elements and receives input from user 101. Client device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Examples of client device 102 may include, but are not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as display unit 109A. In some instances, client device 102 may also establish communications with one or more additional computing systems or devices operating within environment 100 across a wired or wireless communications channel, e.g., via the communications interface 109C using any appropriate communications protocol. Further, user 101 may operate client device 102 and may do so to cause client device 102 to perform one or more exemplary processes described herein.

Merchant computing system 110 and FI computing system 130 may each represent a computing system that includes one or more servers and one or more tangible, non-transitory memory devices storing executable code, application engines, or application modules. Each of the one or more servers may include one or more processors, which may be configured to execute portions of the stored code, application engines, or application modules to perform operations consistent with the disclosed exemplary embodiments. For example, as illustrated in FIG. 1, the one or more servers of FI computing system 130 may include server 132 having one or more processors configured to execute portions of the stored code, application engines, or application modules maintained within the one or more corresponding, tangible, non-transitory memories. In some instances, merchant computing system 110 and/or FI computing system 130 may correspond to a discrete computing system, although in other instances, merchant computing system 110 or FI computing system 130 may correspond to a distributed computing system having multiple, computing components distributed across an appropriate computing network, such as communications network 120 of FIG. 1, or those established and maintained by one or more cloud-based providers, such as Microsoft Azure™, Amazon Web Services™, or another third-party, cloud-services provider. Further, each of merchant computing system 110 and FI computing system 130 may also include one or more communications units, devices, or interfaces, such as one or more wireless transceivers, coupled to the one or more processors for accommodating wired or wireless internet communication across network 120 with other computing systems and devices operating within environment 100 (not illustrated in FIG. 1).

By way of example, merchant computing system 110 may be associated with, or operated by, a merchant 111 that offers products or services for sale to one or more customers, such as, but not limited to, user 101 that operates client device 102. In some instances, merchant computing system 110 may exchange data programmatically with one or more application programs executed at client device 102, such as merchant application 106, and based on the programmatically exchanged data, client device 102 may perform any of the exemplary processes described herein to initiate a transaction to purchase one or more of the products or services offered for sale by merchant 111. Further, and as described herein, FI computing system 130 may be associated with, or operated by, a financial institution that offers financial products or services to one or more customers, such as, but not limited to, user 101. The financial products or services may, for example, include a payment instrument issued to user 101 by the financial institution and available to fund the initiated purchase transaction, and examples of the payment instrument may include, but are not limited to, a credit card account issued by the financial institution, a loan account issued by the financial institution, or a checking, savings, or other deposit account issued by and maintained at the financial institution.

In some instances, FI computing system 130 may perform any of the exemplary processes described herein to obtain, receive, or intercept a request-for-payment (RFP) message associated with an initiated purchase transaction between a first counterparty (e.g., user 101 of FIG. 1) and a second counterparty (e.g., merchant 111 of FIG. 1). As described herein, the received RFP message may be formatted and structured in accordance with one or more standardized data-exchange protocols, such as the ISO 20022 standard for electronic data exchange between financial institutions. Further, and based on elements of mapping data that characterize a structure, composition, or format of one or more data fields of the ISO-20002-compliant RFP message, FI computing system 130 may perform any of the exemplary processes described herein to decompose the received RFP message and obtain data characterizing user 101, merchant 111, and additionally, or alternatively, the initiated purchase transaction. For example, the obtained data may include one or more of: (i) customer data identifying user 101, such as a unique customer identifier (e.g., a customer name, an alphanumeric login credential, etc.) and a postal address; (ii) payment data characterizing the real-time payment transaction, such as a transaction type (e.g., credit, debit, etc.), transaction amount, a requested transaction date or time, an identifier of a product or service involved in the transaction, and an identifier of a customer account (e.g., to which the transaction amount will be credit, or from which the transaction amount will be debited); and (iii) counterparty data identifying the second counterparty, such as a counterparty name (e.g., a merchant name, a financial institution, a vendor, etc.), postal address, or alphanumeric identifier (e.g., a standard industrial classification (SIC) code).

FI computing system 130 may also perform any of the exemplary processes described herein to, based on the data obtained from the message fields of the received RFP message, identify and load additional data (e.g., from a locally accessible data repository) that characterizes user 101, one or more financial services accounts held by user 101, or the interactions between user 101 and the customer financial institution. For example, the customer data extracted from the RFP message may include a name and postal address of user 101, which FI computing system 130 may leverage to access a unique alphanumeric identifier associated with user 101 (e.g., as assigned by the FI computing system 130), demographic data associated with user 101 (e.g., an age, a number of dependents, etc.), account data that identifies one or more financial accounts held by user 101 and issued by the financial institution (e.g., a deposit account, a credit card account, etc.), and additional transaction data that identifies and characterizes transactions involving these accounts (e.g., prior approved transactions involving the merchant, regular payroll deposits into a checking account, etc.). In other examples, the additional data may include credit bureau data associated with user 101, such as a credit score or portions of a credit report.

By way of example, the additional data may characterize one or more previously approved and executed RTP transactions involving corresponding accounts of user 101, which may characterize a cash flow through user 101′s accounts on a granular basis, e.g., a daily or hourly basis. For instance, user 101 may represent an entrepreneur in the gig economy, or an owner of a small business, and user 101 may receive payments from various clients via RTP processes (e.g., RTP-based “pay stubs”) not at predetermined intervals, but instead upon completion of discrete services for corresponding clients. In some examples, through an analysis of these elements of additional transaction data (e.g., the RTP-based pay stubs), FI computing system 130 may determine a real-time cash flow through user 101′s accounts and, as such, gain additional information characterizing the relationship between user 101 and the financial institution, such as a risk (e.g., a relative amount of risk) posed to the financial institution via interactions with user 101.

Based on elements of customer, merchant, payment, and/or transaction data extracted, obtained, or derived from the received RFP message and the obtained additional data, FI computing system 130 may perform operations that identify one or more candidate financial products that are available to user 101 and appropriate to fund the purchase of the products or services from the merchant. In some examples, the available and appropriate ones of the candidate financial products may include a purchase loan, such as an installment loan, which may be offered to user 101 by the financial institution, and which may be characterized by terms and conditions that are tailored to the product or service involved in the purchase transaction, the merchant, and/or user 101′s interaction with the financial institution.

In some instances, to identify candidate financial products that are available to user 101 and that are appropriate to fund the initiated purchase transaction, the FI computing system 130 may perform operations that obtain, from a locally accessible data repository, information that identifies and characterizes a plurality of candidate financial products that are appropriate to fund the initiated purchase transaction. For example, the obtained information may, for each of the candidate financial products, include one or more internal qualification criteria that establish an availability of the candidate financial product to user 101 and that enable the financial institution to establish purchase-, merchant, and/or customer-specific terms and conditions for that candidate financial product, if available.

Further, FI computing system 130 may perform operations that select one of the candidate financial products for processing, and that apply the internal qualification criteria associated with the selected candidate financial product to portions of the customer, merchant, payment, and/or transaction data extracted, obtained, or derived from the received RFP message, and to portions of the obtained additional data. Based on an output of the applied internal qualification criteria, FI computing system 130 may determine whether the selected candidate financial product is available to user 101 and appropriate to the fund the purchase and, if so, generate data characterizing terms and conditions (e.g., a type of the financial product, interest rate, payment schedule, etc.) of the available financial product. In some instances, the FI computing system 130 may repeat these processes for each of the plurality of candidate financial products.

FI computing system 130 may perform further operations that package information identifying one or more of the available and appropriate financial products (e.g., the installment loans described herein), and their corresponding terms and conditions, into corresponding elements of product data. The FI computing system 130 may also perform operations that transmit or “push” a payment notification associated with the RFP message and the elements of product data (e.g., that identify and characterize the available and appropriate financial products and their corresponding terms and conditions) to a device operable by user 101 for presentation within a digital interface, such as to client device 102, e.g., in real-time and contemporaneously with an initiation of the purchase transaction.

To facilitate a performance of one or more of these exemplary processes, FI computing system 130 may maintain, within the one or more tangible, non-transitory memories, a data repository 134 that includes, but is not limited to, a request-for-payment (RFP) queue 136, a mapping data store 138, a customer data store 140, an incentive data store 142, and a candidate financial product store 144. RFP queue 136 may include one or more discrete RFP messages received by FI computing system 130 using any of the exemplary processes described herein. In some instances, the RFP messages maintained within RFP queue 136 may be prioritized in accordance with a time or date of receipt by FI computing system 130 or with requested payment data associated with each of the RFP messages, and each of the prioritized RFP messages may be associated with a corresponding temporal pendency. Further, FI computing system 130 may perform any of the exemplary processes described herein to provision elements of notification data associated with each of the RFP messages to a computing system or device associated with a corresponding customer (e.g., client device 102 associated with user 101), and FI computing system 130 may perform operations that maintain each of the RFP messages within RFP queue 136 until a receipt, at FI computing system 130, of confirmation data from corresponding ones of the computing systems or devices indicating an approval, or a rejection, of the corresponding requested payment, or until an expiration of the corresponding pendency period.

Mapping data store 138 may include structured or unstructured data records that maintain one or more elements of field mapping data 138A. For example, and as described herein, FI computing system 130 may receive, obtain, or intercept one or more RFP messages, each of which may be formatted and structured in accordance with a corresponding, standardized data-exchange protocol, such as the ISO 20022 standard for electronic data exchange between financial institutions. In some instances, the one or more elements of field mapping data 138A may characterize a structure, composition, or format of the message data populating one or more data fields of the ISO-20002-compliant RFP message, or a corresponding RFP message compliant with an additional, or alternate, standardized data-exchange protocol.

Candidate financial product store 144 may include structured or unstructured data records that characterize one or more candidate financial products, such as installment loans and credit cards, that a customer, such as user 101, may use to satisfy a payment requested within a received RFP message, for example. In some instances the data records characterize terms and conditions for each candidate financial product, and further, internal qualification or underwriting procedures for each candidate financial product, as described herein.

In some instances, customer data store 140 may include structured or unstructured data records that maintain information identifying and characterizing one or more customers of the financial institution, and further, interactions between these customers and not only the financial institution, but also other unrelated third parties, such as the merchants or retailers described herein. For example, as illustrated in FIG. 1, customer data store 140 may include one or more elements of transaction data 140A, which identify and characterize prior deposit, purchase, or payment transactions involving the customers of the financial institution (such as, but not limited to, user 101). Further, customer data store 140 may include one or more elements of profile data 140B, which identify and characterize, for each of the customers, one or more of a customer identifier, demographic parameters, financial or budgetary goals (such as an expected cost of a future vacation or a desired balance of a savings account, etc.), and a risk profile (e.g., a risk of defaulting on a payment, such as a loan payment). The risk profile may include, for example, a real-time risk score characterizing a risk of default on a payment, such as a loan payment, and, in some examples, values of transactional metrics that characterize the customers and, in some examples, a peer group for each customer. Customer data store 140 may also include one or more elements of account data 140C, which may identify and characterize one or more financial products, such a credit card account or deposit account, issued to customers by the financial institution or merchants (e.g., merchant 111), and a status of balance of one or more financial products held by the customers.

Incentive data store 142 may include structured or unstructured data records that include elements of digital content that, when presented to user 101 by client device 102 within a corresponding digital interface, identify and provide an incentive for user 101 to initiate a purchase with an alternate financial product, such as a purchase loan characterized by the data records of candidate financial product store 144 and offered to user 101 by the financial institution. By way of example, the incentives associated with the elements of digital content may include, but are not limited to, a savings on interest (e.g., lower interest rate), an interest free period, a cash reward, a gift card, points or credits for a loyalty program, or any other suitable incentive when making the purchase with the alternate financial product as described herein.

In some instances, the structured or unstructured data records of incentive data store 142 may store each of the elements of digital content in conjunction with one or more elements of metadata that, among other things, identify a corresponding merchant associated with the incentive (e.g., a merchant name, etc.) or a corresponding time period associated with the incentive (e.g., a time period to accept a refinance offer, etc.). Further, in some instances, the structured or unstructured data records of incentive data store 142 may store each of the elements of digital content in conjunction with one or more elements of layout data, which specify a disposition of the elements of digital content, or visual characteristics of the elements of digital content, when rendered for presentation within a corresponding digital interface by one or more application programs executed by client device 102.

Further, and to facilitate the performance of any of the exemplary processes described herein, FI computing system 130 may also maintain, within the one or more tangible, non-transitory memories, an application repository 145 that maintains, but is not limited to, a decomposition engine 146, an analytical engine 148, and a notification engine 150, each of which may be executed by the one or more processors of server 132.

For example, and upon execution by the one or more processors of Fl computing system 130, executed decomposition engine 146 may perform any of the exemplary processes described herein to obtain field mapping data 138A from mapping data store 138, to apply field mapping data 138A to a received, obtained, or intercepted RFP message, and based on the application of field mapping data 130A to the RFP message, to decompose the RFP message and obtain elements of message data that not only identify and characterize each counterparty involved in an initiated purchase transaction (e.g., user 101 and merchant 111, described herein), but that also characterize the initiated purchase transaction.

Further, and upon execution by the one or more processors of Fl computing system 130, executed analytical engine 148 may perform any of the exemplary processes described herein to process the elements of message data obtained from the message fields of the RFP message to identify and load, from a locally accessible data repository (e.g., customer data store 140), additional data that characterizes the customer, one or more financial services accounts held by the customer, or the interactions between the customer and the customer financial institution. For example, customer data extracted from an RFP message may include a customer's name and the customer's address. Executed analytical engine 148 may leverage the customer's name or address to access one or more of profile data 140B associated with the customer (e.g., an age, a number of dependents, a credit report, a unique alphanumeric identifier associated with the customer, etc.), account data 140C that identifies one or more financial accounts held by the customer and issued by the financial institution (e.g., a deposit account, a credit card account, etc.), and transaction data 140A that identifies and characterizes transactions involving these accounts (e.g., prior approved transactions involving the merchant, regular payroll deposits into a checking account, etc.). Based on elements of customer, merchant, payment, and/or transaction data extracted, obtained, or derived from the received RFP message, and the additional data obtained from the locally accessible data repository, executed analytical engine 148 of the FI computing system 130 may identify one or more candidate financial products that are available to the customer and appropriate to fund the purchase of the products or services from the merchant identified within the received RFP message.

In some instances, to identify candidate financial products that are available to the customer and that are appropriate to fund the initiated purchase transaction, executed analytical engine 148 of the FI computing system 130 may perform operations that obtain, from a locally accessible data repository (e.g., candidate financial product store 144), information that identifies and characterizes a plurality of candidate financial products that are appropriate to fund the initiated purchase transaction. Additionally, executed analytical engine 148 of the FI computing system 130 may perform operations that select one of the candidate financial products for processing, and that apply an internal qualification or underwriting criteria associated with the selected candidate financial product to portions of the customer, merchant, payment, and/or transaction data extracted, obtained, or derived from the received RFP message and to portions of the additional data obtained from the locally accessible data repository. Further, and based on an output of the applied internal qualification criteria, executed analytical engine 148 may determine whether the selected candidate financial product is available to the customer and appropriate to the fund the purchase. If executed analytical engine 148 determines that the selected candidate financial product is available to the customer and appropriate to the fund the purchase, executed analytical engine 148 may further generate terms and conditions the available financial product.

Upon execution by the one or more processors of FI computing system 130, notification engine 150 may perform any of the exemplary processes described herein to generate one or more elements of notification data that include one or more of the information identifying each of the available and appropriate financial products and, additionally or alternatively, their corresponding terms and conditions. In some instances, when provisioned to client device 102 by FI computing system 130, the elements of notification data may cause one or more application programs executed by client device 102 (e.g., mobile banking application 108) to present interface elements within a corresponding digital interface that offer the available and appropriate financial products and portions of their corresponding terms and conditions, and that prompt user 101 to accept one or more of the offered financial products and agree to fund the real-time payment requested by merchant 111 via the RFP message using the one or more accepted financial products, e.g., contemporaneously with the initiation of the purchase transaction. In other instances, the notification data may also include a payment notification that, when provisioned to client device 102 by FI computing system 130, causes one or more application programs executed by client device 102 (e.g., mobile banking application 108) to present interface elements within a corresponding digital interface that prompt user 101 to provide an approval of the real-time payment requested by merchant 111 via the RFP message, e.g., in response to a rejection by user 101 of the offered financial products.
B. Real-Time Generation and Provisioning Targeted Product Data based on Structured Messaging Data

In some instances, a customer of the financial institution, such as user 101, may elect to initiate a purchase of a product or service from a particular merchant, such as merchant 111, and may provide input to client device 102 (e.g., via input unit 109B) that triggers an execution of one or more locally maintained application programs associated with merchant 111, such as merchant application 106. By way of example, merchant 111 may correspond to a furniture shop (e.g., “Barry's Furniture Shop”)., and upon execution by the one or more processors of client device 102, executed merchant application 106 may perform operations that present, via display unit 109A, a digital interface 200 that enables user 101 to select for purchase one or more products offered for sale by merchant 111 (e.g., couches, coffee tables, entertainment sets, etc.), and to submit payment for the products to merchant 111, prior to arriving at the furniture shop and collecting the purchased products, or having the purchased products delivered to user 101's home, for example.

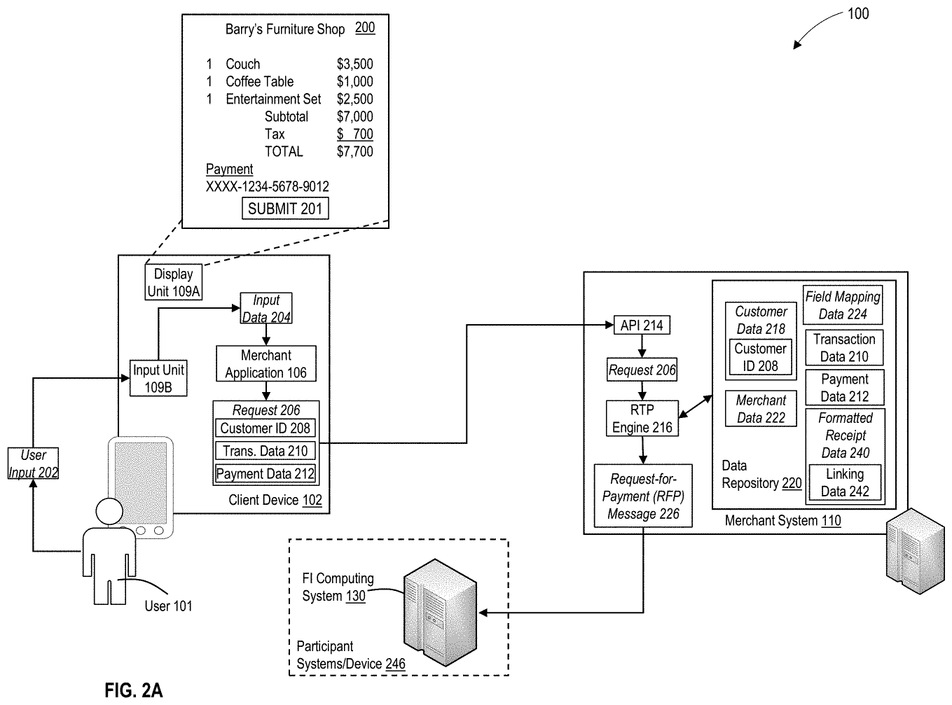

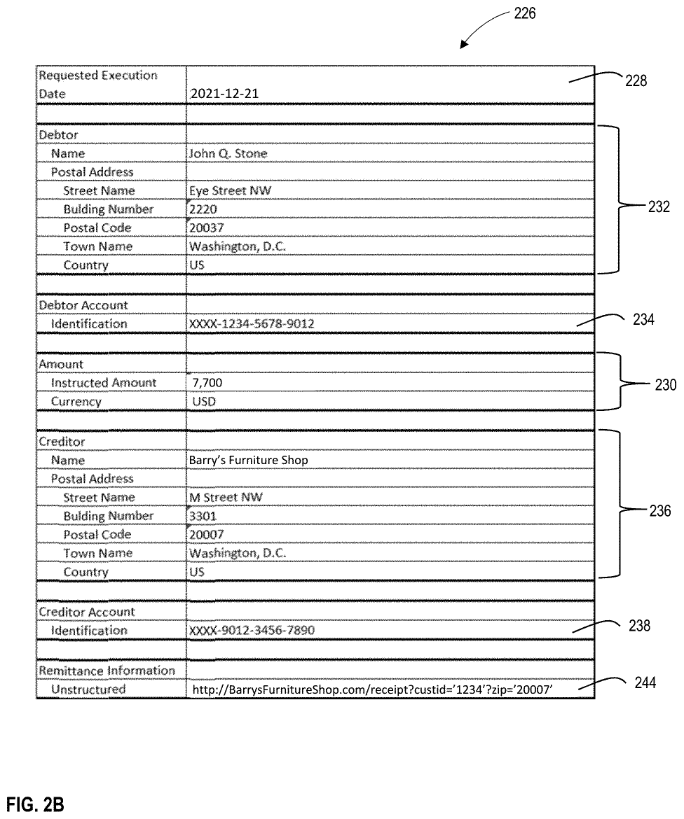

Based on portions of a digital interface, user 101 may provide input to input device 109B of client device 102 that specifies a selection of a couch, a coffee table, and an entertainment set for purchase and that specifies a particular payment instrument available to fund the purchased products (e.g., a credit card account or deposit issued to user 101 by the financial institution, etc.). For example, as illustrated in FIG. 2A, digital interface 200 may include interface elements that specify the selection, by user 101, of a couch priced at $3,500, a coffee table priced at $1,000, and an entertainment set priced at $2,500, and that specify a pre-tax subtotal of $7000 and an imposed sales tax of $700, and further, a total purchase price of $7,700. Further, the interface elements may also specify payment data that identifies the particular payment instrument available to fund the purchase transaction, such as an account number (e.g., “XXXX-1234-5678-9012”), an expiration date, and/or a card verification code. As illustrated in FIG. 2A, all or a selected portion of the payment data presented within digital interface 200 may be tokenized or otherwise obscured to, among other things, maintain a confidentiality of the presented elements of payment data.

Further, as illustrated in FIG. 2A, digital interface 200 may also include a selectable interface element, such as “SUBMIT” icon 201, that when selected by user 101, confirms an intention of user 101 to initiate the $7,700 purchase of the couch, coffee table, and entertainment set with the particular payment instrument, and requests a submission of corresponding elements of transaction and payment information to a computing system associated with merchant 111, e.g., merchant computing system 110. For example, input device 109B of client device 102 may receive additional input 202 indicative of a selection, by user 101, of SUBMIT icon 201, and may route, to executed merchant application 106, input data 204 that includes, but is not limited to, information specifying the purchased products, the subtotal, imposed sales tax, and total purchase price, and the particular payment instrument that funds the initiated purchase transaction.

In some instances, executed merchant application 106 may package all, or a selected portion, of input data 204 into corresponding portions of a purchase request 206, and may perform operations that cause client device 102 to transmit purchase request 206 across network 120 to a computing system associated with merchant 111, such as merchant computing system 110. Further, although not illustrated in FIG. 2A, executed merchant application 106 may also perform operations that encrypt all, or a portion, of purchase request 206 using an appropriate encryption key (e.g., a public cryptographic key of merchant computing system 110, etc.) prior to transmission across network 120.

In some instances, purchase request 206 may include a customer identifier 208 associated with user 101 (e.g., an alphanumeric login credential that uniquely identifies user 101 at merchant computing system 110), elements of transaction data 210 that specify values of one or more parameters characterizing the initiated purchase transaction, and elements of payment data 212 that specify the particular payment instrument selected to fund the purchase transaction. For example, the elements of transaction data 210 may include an identifier of each of the purchased products (e.g., a universal product code (UPC) associated with each of the couch, coffee table, and entertainment set, etc.), the subtotal for the purchase transaction (e.g., $7,000), the imposed sales tax (e.g., $700), the total purchase price (e.g., $7,700), and a time or date of the initiated purchase transaction (e.g., 9:30 a.m. on Dec. 21, 2021). Additionally, in some examples, the elements of payment data 212 may include, among other things, all or a selected portion of the account number (e.g., in tokenized form, etc.), the corresponding expiration data, and/or the corresponding card verification code.

A programmatic interface established and maintained by merchant computing system 110, such as application programming interface (API) 214, may receive purchase request 206 from client device 102, and may route purchase request 206 to a real-time payment (RTP) engine 216 executed by the one or more processors of merchant computing system 110. In some instances, as described herein, all, or a selected portion, of purchase request 206 may be encrypted, and executed RTP engine 216 may perform operations that decrypt the encrypted portions of purchase request 206 using a corresponding, and appropriate, decryption key, such as a private cryptographic key associated with merchant computing system 110. Executed RTP engine 216 may also perform operations that, based on portions of purchase request 206, verify that user 101 represents a registered customer of merchant 111. For example, executed RTP engine 216 may parse purchase request 206 and obtain customer identifier 208, which uniquely identifies user 101, and identify one or more elements of customer data associated with customer identifier 208 within a corresponding merchant data repository 220. The identified elements of customer data 218 may include, among other things, a full name of user 101 and a postal address of user 101, and based on the identification of the elements of customer data 218 and their association with customer identifier 208, executed RTP engine 216 may verify that user 101 represents a registered customer of merchant 111.

Executed RTP engine 216 may also extract, from merchant data repository 220, one or more elements of merchant data 222 and one or more elements of field mapping data 224. In some instances, the one or more elements of merchant data 222 may include, but are not limited to, an identifier of merchant 111 (e.g., a merchant name, such as “Barry's Furniture Shop”), a postal address associated with merchant 111 (e.g., an actual postal address, a generic postal address, etc.), and information that identifies a financial services account associated with merchant 111 and capable of receiving proceeds from one or more of the purchased transactions described herein (e.g., an account number, a routing number, etc.). Further, the one or more elements of field mapping data 224 may characterize a structure, composition, or format of one or more data fields of an ISO-20002-compliant RFP message, such as those described herein, and additionally, or alternatively, an RFP message compliant with another standardized data-exchange protocol.

Executed RTP engine 216 may parse purchase request 206 and obtain the one or more elements of transaction data 210 that specify the parameter values characterizing the initiated purchase transaction, and elements of payment data 212 that specify the particular payment instrument selected to fund the initiated purchase transaction. In some instances, based on portions of the elements of transaction data 210, payment data 212, customer data 218, and merchant data 222, executed RTP engine 216 may perform any of the exemplary processes described herein to generate a request-for-payment (RFP) message 226 that is structured and formatted in accordance with the one or more elements of field mapping data 224 and that requests a payment from user 101 for the initiated purchase transaction (e.g., the $7,700 purchase of the couch, coffee table, and entertainment set at 9:30 a.m. on Dec. 21st) not at a close of a corresponding business or calendar day, but instead in real-time and contemporaneously with the initiation of the purchase transaction by client device 102. As described herein, RFP message 226 may be structured in accordance with the ISO 20022 standard for electronic data exchange between financial institutions, and in some examples, RFP message 226 may correspond to a pain.013 message as specified within the ISO 20022 standard. Further, and as described herein, the one or more elements of field mapping data 224 may characterize a structure, composition, or format of one or more data fields of ISO-20002-compliant RFP message 226 (e.g., the one or more data fields within the pain.013 message).

By way of example, ISO-20022-compliant RFP message 226 may include among other things: (i) message fields populated with data specifying a full name and postal address of user 101; (ii) message fields populated with data identifying a payment instrument selected by user 101 to fund the initiated purchase transaction; (iii) message fields populated with data specifying a name and postal address of merchant 111; (iv) message fields populated with data identifying a financial services account held by merchant 111 and available to receive processed from the requested payment; and (v) message fields populated with one or more parameter values that characterize the initiated purchase transaction, a requested payment method, and/or a requested payment date. Further, ISO-20022-compliant RFP message 226 may also include one or more structured or unstructured message fields that specify additional information associated with the initiated purchase transaction.

Examples of the additional information include, but are not limited to, information identifying a product or service involved in the initiated purchase transaction, or a link to remittance data associated with the initiated transaction (e.g., a link to a PDF or HTML invoice identifying the merchant/vendor, the geographic location of the merchant/vendor, or the purchased product or service). In some instances, as described herein, the link may include a long-form uniform resource locator (URL) into which certain elements of positional or customer data may be embedded, such as, but not limited to, the actual postal code of merchant 111 or the unique identifier of user 101. In other instances, the link may include a shortened URL, such as a tiny URL, actionable by Fl computing system 130 using any of the exemplary processes described herein.

In some instances, executed RTP engine 216 may parse the elements of transaction data 210, payment data 212, customer data 218, and merchant data 222, and may perform operations that populate the message fields of RFP message 226 with corresponding elements of elements of transaction data 210, payment data 212, customer data 218, and merchant data 222 in accordance with field mapping data 224. For example, executed RTP engine 216 may parse transaction data 210 and obtain data that specifies a requested payment date (e.g., Dec. 21, 2021), a requested payment amount (e.g., the $7,700 total purchase price), and a currency associated with that requested payment amount (e.g., U.S. dollars). Executed RTP engine 216 may also format the requested payment data, the requested payment amount, and the requested payment currency in accordance with portions of field mapping data 224. As illustrated in FIG. 2B, executed RTP engine 216 may perform operations that populate message field 228 of RFP message 226 with the formatted payment date (e.g., “2021-12-21”) and message fields 230 of RFP message 226 with respective ones of the formatted payment amount (e.g., “7,700”) and formatted payment current (e.g., “USD”).

Further, executed RTP engine 216 may parse the elements of customer data 218 to obtain a name of user 101 (e.g., “John Q. Stone”) and a postal address associated with user 101 (e.g., “2223 Eye Street NW, Washington, D.C., 20037, US”), and may parse the elements of payment data 212 to obtain information that identifies (e.g., an “identification” of) the payment instrument selected by user 101 to fund the purchase transaction (e.g., the account number “XXXX-1234-5678-9012”). In some instances, executed RTP engine 216 may format the obtained customer name, the obtained customer address, and the obtained identification of the payment instrument in accordance with portions of field mapping data 224, and as illustrated in FIG. 2B, executed RTP engine 216 may perform operations that populate message fields 232 of RFP message 226 with respective portions of the formatted customer name and customer address, and that populate message field 234 with the formatted identification of the selected payment instrument.

Executed RTP engine 216 may also parse the elements of merchant data 222 to obtain a name of merchant 111 (e.g., “Barry's Furniture Shop”), a postal address associated with merchant 111 (e.g., “3301 M Street NW, Washington, D.C., 20007, US”), and that identifies (e.g., an “identification” of) a financial services account associated with merchant 111 and capable of receiving proceeds from one or more of the purchased transactions (e.g., the account number “XXXX-9012-3456-7890”). In some instances, executed RTP engine 216 may format the obtained merchant name, the obtained merchant address, and the obtained identification of the merchant account in accordance with portions of field mapping data 224, and as illustrated in FIG. 2B, executed RTP engine 216 may perform operations that populate message fields 236 of RFP message 226 with respective portions of the formatted merchant name and merchant address, and that populate message field 238 with the formatted identification of the merchant account.

Further, and as described herein, RFP message 226 may also include one or more message fields that specify remittance information associated with the initiated purchase transaction, such as, but not limited to, a link to a PDF or HTML invoice identifying merchant 111, a postal address associated with merchant 111, or the purchased products or services. For example, and upon receipt of purchase request 206, merchant computing system 110 (e.g., via executed RTP engine 216 or one or more other executed application programs, engines, or modules) may generate one or more elements of formatted receipt data 240 that identify merchant 111 (e.g., “Barry's Furniture Shop”), a postal address associated with merchant 111 (e.g., “3301 M Street NW, Washington, D.C., 20007, US”), and one or more elements of transaction data 210 (e.g., names and/or UPCs of the purchased couch, coffee table, and entertainment set, the $7,000 subtotal of the purchase transaction, the $700 sales tax, the $7,700 total purchase amount, etc.) or payment data 212 (e.g., a tokened portion of the account number of the selected payment instrument, etc.). In some instances, merchant computing system 110 may perform operations that store the elements of formatted receipt data 240 within a portion of data repository 220, along with corresponding elements of linking data 242 that include, among other things, a long-form or shortened URL associated with the stored elements of formatted receipt data 240 (e.g., that point to the storage location of formatted receipt data 240 within data repository 220).

In some instances, executed RTP engine 216 may perform operations that obtain linking data 242 from data repository 220, and that process and package all, or a selected portion, of linking data 242 within a corresponding unstructured message field of RFP message 226. For example, linking data 242 may include a long-form URL that points to formatted receipt data 240 maintained within data repository 220 and includes the actual postal code of merchant 111 (e.g., “20007”) and the customer identifier of user 101 (e.g., http://www.BarrysFurnitureShop.com/receipt?custid=‘1234’?zip=‘20007’), and as illustrated in FIG. 2B, executed RTP engine 216 may parse linking data 242, obtain the long-form URL, and package the long-form URL into an unstructured message field 244 of RFP message 226. The disclosed embodiments are, however, not limited to RFP messages populated with these exemplary elements of customer, merchant, payment, transaction, and additional remittance data, and in other examples, RFP message 226 may include any additional, or alternate, message fields specified within field mapping data 224 and consistent with the ISO 20022 standard for electronic data exchange, and executed RTP engine 216 may populate these message fields with any additional, or alternate, structured and formatted elements of customer, merchant, payment, transaction, or additional remittance data appropriate to RFP message 226 and field mapping data 224.

As illustrated in FIG. 2A, executed RTP engine 216 may perform operations that cause merchant computing system 110 to broadcast now-populated RFP message 226 across network 120 to one or more computing systems or devices 246 within environment 100 that are associated with participants in the RTP ecosystem, such as, but not limited to, FI computing system 130 or client device 102. In some instances, and prior to broadcasting now-populated RFP message 226 across network 120, executed RTP engine 216 may perform operations that encrypt RFP message 226 using a corresponding encryption key, and examples of the corresponding encryption key include, but are not limited to, a public cryptographic key associated with FI computing system 130.

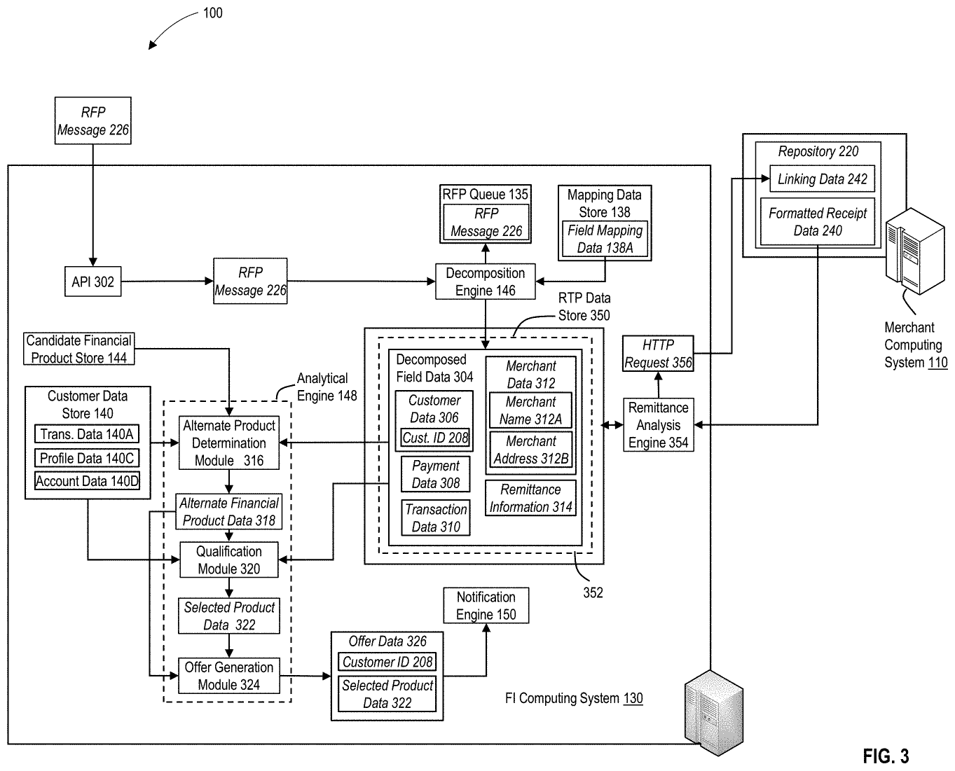

Referring to FIG. 3, a programmatic interface established and maintained by FI computing system 130, such as application programming interface (API) 302, may receive RFP message 226, and may route RFP message 226 to decomposition engine 146, which may be executed by the one or more processors of FI computing system 130. In some examples, FI computing system 130 may receive RFP message 226 directly across network 120 via a channel of communications established programmatically between API 302 and executed RTP engine 216 of merchant computing system 110. In other examples, FI computing system 130 may receive RFP message 226 across network 120 from one or more of computing systems or devices 246 associated with the participants in the RTP ecosystem. Further, and as described herein, one or more portions of RFP message 226 may be encrypted (e.g., using a public cryptographic key associated with FI computing system 130), and executed decomposition engine 146 may perform operations that access a corresponding decryption key maintained within the one or more tangible, non-transitory memories of FI computing system 130 (e.g., a private cryptographic key associated with FI computing system 130), and that decrypt the encrypted portions of RFP message 226 using the corresponding decryption key.

In some instances, executed decomposition engine 146 may store RFP message 226 (in decrypted form) within a corresponding portion of data repository 134, e.g., within RFP queue 136. Executed decomposition engine 146 may also perform operations that access mapping data store 138 (e.g., as maintained within data repository 134), and obtain one or more elements of fields mapping data 138A that characterize a structure, composition, or format of one or more data fields of RFP message 226. For example, and as described herein, RFP message 226 may include message fields consistent with the ISO 20022 standard for electronic data exchange between financial institutions, and each of the message fields may be populated with data structured and formatted in accordance with the ISO 20022 standard.

As described herein, RFP message 226 may be associated with a real-time payment of a monetary amount, such as $7,700, requested from user 101 by merchant 111 for purchased goods, such as the couch, coffee table, and entertainment set purchased on Jun. 15, 2021. By way of example, RFP message 226 may include, but is not limited to, a message field populated with data specifying the requested payment date of December 21st (e.g., message field 228 of FIG. 2B) and message fields populated within data specifying the requested payment amount of US $7,700 (e.g., message fields 230 of FIG. 2B). RFP message 226 may also include, but is not limited to, message fields populated with data that identify and characterize user 101 (e.g., message fields 232 of FIG. 2B) and merchant 111 (e.g., message fields 236 of FIG. 2B), along with additional message fields populated with data that identify the payment instrument selected by user 101 to fund the purchase transaction (e.g., message field 234 of FIG. 2B) and the financial services account associated with merchant 111 and capable of receiving proceeds from the purchase transaction (e.g., message field 238 of FIG. 2B). Further, and as described herein, RFP message 226 may include one or more additional data fields populated with structured or unstructured remittance data, such as, but not limited to, a long-form URL that points to formatted receipt data 240 maintained within data repository 220 (e.g., message field 244 of FIG. 2B, which may include http://BarrysFurnitureShop.com/receipt?custid=‘1234’?zip=‘20007’). The disclosed embodiments are, however, not limited to structured or unstructured remittance data that includes a long-form URL, and in other instances, the structured or unstructured remittance data may include one or more identifiers (e.g., UPCs, etc.) of the purchased products or a shortened URL that points to formatted receipt data 240.

Based on the obtained elements of field mapping data 138A, executed decomposition engine 146 may perform operations that parse RFP message 226 and obtain elements of decomposed field data 304 that identify and characterize user 101, merchant 111, and the requested payment for the corresponding purchase transaction, such as the purchase transaction initiated on Jun. 15, 2021. In some instances, and through the performance of these exemplary operations, executed decomposition engine 146 may “decompose” the structured or unstructured data populating the message fields of RFP message 226 in accordance with field mapping data 138A, and generate the elements of decomposed field data 304 that include, but is not limited to, elements of customer data 306, payment data 308, transaction data 310, and merchant data 312.

By way of example, and based on the elements of field mapping data 138A, executed decomposition engine 146 may determine that message fields 232 of RFP message 226 include data that identifies and characterizes user 101, and may perform operations that obtain, from message fields 232, a customer name of user 101 (e.g., “John Q. Stone”) and a customer address of user 101 (e.g., “2220 Eye Street NW, Washington, D.C., 20037, US”). Further, as illustrated in FIG. 3. executed decomposition engine 146 may package the obtained customer name and address into corresponding portions of customer data 306.

Further, based on the elements of field mapping data 138A, executed decomposition engine 146 may determine that message fields 228 and 234 of RFP message 226 include data identifying respective ones of the requested payment date and the payment instrument selected by user 101 to fund the purchase transaction. In some instances, executed decomposition engine 146 may perform operations that obtain, from respective ones of message fields from message fields 228 and 234, the requested payment date of Jun. 15, 2021 and the information that identifies the selected payment instrument (e.g., the account number “XXXX-1234-5678-9012”), which executed decomposition engine 146 may package into corresponding portions of payment data 308. Executed decomposition engine 146 may also determine, based on the elements of field mapping data 138A, that message fields 230 of RFP message 226 include data identifying the requested payment amount and the currency associated with that requested payment amount. In some instances, executed RTP engine 216 may perform operations that obtain, from respective ones of message fields 230, data that identifies the $7,700 requested payment amount and the requested denomination in U.S. currency, and package the obtained data within corresponding portions of transaction data 310.

In some instances, and based on the elements of field mapping data 138A, executed decomposition engine 146 may determine that message fields 236 and 238 include data that identifies and characterizes merchant 111, and that identifies the financial services account associated with merchant 111 and that is capable of receiving proceeds from the purchase transaction. Executed decomposition engine 146 may perform operations that obtain, from message fields 236, a name of merchant 111 (e.g., “Barry's Furniture Shop”) and a postal address associated with merchant 111 (e.g., “3301 M Street NW, Washington, D.C., 20007, US”), and that obtain, from message field 238, the information identifying the financial services account associated with merchant 111 (e.g., the account number “XXXX-9012-3456-7890” of the merchant account). Further, executed decomposition engine 146 may perform additional operations that package the obtained merchant name, the obtained merchant address, and the obtained information identifying the merchant account into corresponding portions of merchant data 312 (e.g., merchant name 312A, merchant address 312B).

Additionally, and as described herein, executed decomposition engine 146 may also determine, based on the elements of field mapping data 138A, that message field 244 of RFP message 226 includes structured or unstructured elements of remittance data that characterizes further the initiated purchase transaction, user 101, or merchant 111, and executed decomposition engine 146 may obtain the structured or unstructured elements remittance data from message field 244 and package the obtained elements of remittance data into corresponding portions of remittance information 314. For example, the elements of structured or unstructured remittance data may include the long-form URL that points to formatted receipt data 240 maintained within data repository 220 and that includes contact information of merchant 111 (e.g., address, phone number, web address, etc.), and executed decomposition engine 146 may obtain the long-form URL from message field 244 of RFP message 226, and package that long-form URL into remittance information 314.

The disclosed embodiments are, however, not limited to elements of structured or unstructured remittance data that include a long-form URL pointing to formatted receipt data maintained within data repository 220 of merchant computing system 110. In other instances, the structured or unstructured remittance data maintained within message field 244 of RFP message 226 (or within additional, or alternate, message fields of RFP message data 226) may include an additional, or alternate, long-form URL pointing to formatted receipt data maintained at merchant computing system 110 or at other computing systems within environment 100, a shortened URL (e.g., a tiny URL) actionable by FI computing system 130 and pointing to formatted receipt data maintained at merchant computing system 110 or at other computing systems within environment 100, or other elements of data that identify or characterize user 101, merchant 111, or the purchase transaction, such as UPCs of the couch, coffee table, and entertainment set.

In some instances, the one or more processors of FI computing system 130 may execute a remittance analysis engine 354, which may perform operations that, based on the long-form or shortened URL maintained within remittance information 314 of decomposed field data 304, programmatically access elements of formatted receipt data 240 maintained at Merchant computing system 110 of the second financial institution, and that process the accessed elements of formatted receipt data 240 to obtain additional, or alternate, elements of customer data 306, payment data 308, transaction data 310, and merchant data 312. For example, remittance analysis engine 354 may access the long-form or shortened URL maintained within remittance information 314 (e.g., the short- or long-form URL described herein, etc.), and may process the long-form or shortened URL and generate a corresponding HTTP request 356 for the elements of formatted receipt data 240 maintained at Merchant computing system 110. Executed remittance analysis engine 354 may also perform operations that cause Fl computing system 130 to transmit HTTP request 356 across network 120 to Merchant computing system 110.

Merchant computing system 110 may, for example, receive HTTP request 356, and based on portions of HTTP request 356 and linking data 242 (e.g., based on a determined match or correspondence between the portions of HTTP request 356 and linking data 242), Merchant computing system 110 may perform operations that obtain the elements of formatted receipt data 240 from data repository 220, and that transmit the elements of formatted receipt data 240 across network 120 to FI computing system 130, e.g., as a response to HTTP request 356. Further, as illustrated in FIG. 3A, executed remittance analysis engine 354 may receive the elements of formatted receipt data 240 from Merchant computing system 110, and may perform any of the exemplary processes described herein to parse the elements of formatted receipt data 240 (e.g., in a received format, such as a PDF or HTML form, or in a transformed or enhanced format, etc.) and obtain, from the parsed elements of formatted receipt data 240 , one or more of the additional, or alternate, elements of customer data 306, payment data 308, transaction data 310, or merchant data 312. By way of example, executed remittance analysis engine 354 may apply one or more optical character recognition (OCR) processes or optical word recognition (OWR) processes to the elements of formatted receipt data 240 in PDF form to generate, or obtain, elements of textual content representative of the data that characterize user 101, the second financial institution, the loan product issued by the second financial institution, or the requested payment.

By way of example, executed remittance analysis engine 354 may perform operations that detect a presence one or more keywords within the generated elements of textual content (e.g., “UPC,” “address,” “subtotal,” etc.), and may extract elements of the textual content associated with these keywords as corresponding ones of the additional, or alternate, elements of customer data 306, payment data 308, transaction data 310, or merchant data 312. In other examples, executed remittance analysis engine 354 may detect a presence of the additional, or alternate, elements of customer data 306, payment data 308, transaction data 310, or merchant data 312 within the generated textual content based on an application of one or more adaptively trained machine learning or artificial intelligence models to portions of the textual content, and examples of these adaptively trained machine learning or artificial intelligence models includes a trained neural network process (e.g., a convolutional neural network, etc.)or a decision-tree process that ingests input datasets composed of all, or selected portions, of the textual content. The disclosed embodiments are, however, not limited to exemplary processes for detecting and extracting one or more of the additional, or alternate, elements of customer data 306, payment data 308, transaction data 310, or merchant data 312 from the generated textual content, and in other instances, executed remittance analysis engine 354 may perform any additional, or alternate, process for identifying one or more of the additional, or alternate, elements of customer data 306, payment data 308, transaction data 310, or merchant data 312 within the textual content derived from the processing of the elements of formatted receipt data 240 in PDF format.

Further, and as described herein, the elements of formatted receipt data 240 may be structured in HTML form, and may include metadata that identify and characterize user 101 (e.g., the customer name, etc.), the second financial institution (e.g., the name or other identifier, etc.), the requested payment (e.g., a payment amount, etc.), or the loan product issued by the second financial institution (e.g., an interest rate, an amount of remaining principal, etc.). Executed remittance analysis engine 354 may perform operations that detect one or more of the elements of metadata within the elements of formatted receipt data 240 , and that obtain, from the elements of metadata, additional, or alternate, elements of customer data 306, payment data 308, transaction data 310, or merchant data 312, as described herein. The disclosed embodiments are, however, not limited to these exemplary processes for detecting and extracting the additional, or alternate, elements of customer data 306, payment data 308, transaction data 310, or merchant data 312 from HTML-formatted receipt data, and in other instances, executed remittance analysis engine 354 may perform any additional, or alternate, process detecting and obtaining data from the elements of formatted receipt data 240 structured in HTML form, including, but not limited to, an application of one or more screen-scraping processes to portions of formatted receipt data 240 structured in HTML form.

The disclosed embodiments are, however, not limited to elements of structured or unstructured remittance data that include a long-form or shortened URLs pointing to formatted receipt data maintained within data repository 220 of merchant computing system 110. In other instances, the structured or unstructured remittance data maintained within message field 244 of RFP message 226 (or within additional, or alternate, message fields of RFP message 226) may include an additional, or alternate, long-form URL pointing to formatted receipt data maintained at merchant computing system 110 or at other computing systems within environment 100, a shortened URL (e.g., a tiny URL) actionable by FI computing system 130 and pointing to formatted receipt data maintained at merchant computing system 110 or at other computing systems within environment 100, or other elements of data that identify or characterize user 101, merchant 111, or the purchase transaction, such as UPCs of the running shoes or socks.

In some instances, executed decomposition engine 146 may perform operations that store decomposed field data 304, which includes the element of customer data 306, payment data 308, transaction data 310, merchant data 312, and remittance information 314, within a corresponding portion of data repository 134, such as within an element 352 of RTP data store 350. In some examples, data repository 134 further stores other information characterizing customers of the financial institution, such as, but not limited to, profile data that characterizes each of the customers (e.g., values of demographic parameters of the customers, financial or budgetary goals of the customer, such as an expected cost of a future vacation or a desired balance of a savings account, etc.), account data that identifies and characterizes a status of balance of one or more financial accounts held by the customers, transaction data that characterizes prior deposit or purchase transactions involving the customers of the financial institution, and loyalty data, that characterizes one or more merchant- or retailer-specific loyalty programs in which the customers of the financial institution participate.

In some instances, executed decomposition engine 146 may access RFP queue 136, and determine whether RFP queue 136 includes additional RFP messages awaiting decomposition. For example, FI computing system 130 may receive additional RFP messages 226, and may store these additional RFP messages 226 within RFP queue 136 on a continuous and ongoing basis (e.g., throughout each day). If the executed decomposition engine 146 were to determine that additional RFP messages 226 within RFP queue 136 await processing, executed decomposition engine 146 may obtain one of the additional RFP messages 226, and may perform any of the exemplary processes described herein to decompose the message fields of the obtained, additional RFP message in accordance with the elements of field mapping data 138A, to obtain corresponding elements of customer data, payment data, transaction data, merchant data, and remittance information, and to package the customer data, payment data, transaction data, merchant data, and remittance information into additional, decomposed field data for storage within an element of RTP data store 350.

Further, executed decomposition engine 146 may provide decomposed field data 304 as an input to analytical engine 148 of FI computing system 130. Upon execution by the one or more processors of FI computing system 130, executed analytical engine 148 may perform any of the exemplary processes described herein to determine one or more candidate financial products for the corresponding customer (e.g., user 101) based on portions of decomposed field data 304, either alone or in conjunction with additional data associated with user 101, client device 102, merchant 111, or previously initiated transactions involving user 101 and client device 102.

For example, as illustrated in FIG. 3, an alternate product determination module 316 of executed analytical engine 148 may perform operations that access candidate financial product store 144 and identifies candidate financial products that are available to user 101 and that are appropriate to fund the initiated purchase transaction. For example, the obtained information may, for each of the candidate financial products, include one or more internal qualification or underwriting criteria that establish an availability of the candidate financial product to user 101 and enable the financial institution to establish purchase-, merchant, and/or customer-specific terms and conditions. The purchase-, merchant, and/or customer-specific terms and conditions may include, for example, a minimum average monthly balance in one or more deposit accounts, an average payroll deposit amount received by user 101's financial accounts on a daily, weekly, yearly, or monthly basis, and additionally, or alternatively, an average amount saved by user 101 (e.g., as a difference between the payroll deposit amount and the payment amounts over a particular temporal interval) on a daily, weekly, monthly, or yearly basis, etc.) for that candidate financial product. For each of the candidate financial products, executed alternate product determination module 316 may generate alternate financial product data 318A charactering the corresponding candidate financial product (e.g., payment plan, interest rate, late payment penalty, minimum payment, payment interval) and, additionally or alternatively, the one or more internal qualification criteria, including any of the corresponding purchase-, merchant, and/or customer-specific terms and conditions.

In some instances, executed alternate product determination module 316 may perform operations that access one or more of customer data 306, payment data 308, transaction data 310, and merchant data 312 within decomposed field data 304 to determine an availability of a particular candidate financial product to user 101. For example, executed alternate product determination module 316 may perform operations that access the transaction data 310 with decomposed field data 304, and determine a payment amount (e.g., the $7,700) for the requested payment. Based on the payment amount, executed alternate product determination module 316 may determine that one or more of the candidate financial products characterized within candidate financial product store 144 are available to fund the requested payment, and may, additionally or alternatively, determine that one or more other candidate financial products characterized within candidate financial product store 144 are not available to fund the requested payment. For example, and to be available to fund the requested payment. each candidate financial product may be associated with a minimum payment amount disposed at, or above, a threshold value (e.g., the $7,700 payment amount of the requested payment).

Further, in some examples, alternate product determination module 316 may perform operations that determine an availability of a particular candidate financial product to fund the requested payment based on the access merchant data 312 within decomposed field data 304. For example, a candidate financial product may associated with, and may be available to fund purchases involving, a particular merchant, and executed alternate product determination module 316 may obtain merchant name 312A (e.g., “Barry's Furniture Shop”) from merchant data 312, and based on merchant name 312A, executed alternate product determination module 316 may determine the availability of the candidate financial product to fund purchases involving the particular merchant (e.g., “Barry's Furniture Shop”).

As illustrated in FIG. 3, executed alternate product determination module 316 may provide alternative financial product data 318, which characterizes the one or more available candidate financial products, as an input to a qualification module 320 of executed analytical engine 148. Executed qualification module 320 may, for example, receive alternate financial product data 318A, and may perform further operations that access customer data 306 within decomposed field data 304 and obtain a customer identifier associated with user 101, such as customer identifier 208. Further, and based on customer identifier 208, executed qualification module 320 may obtain, from customer data store 140, elements of transaction data 140A, profile data 140B, and account data 140C that include, or reference, customer identifier 208 and as such, are associated with user 101. Executed qualification module 320 may also perform operations that, based on customer identifier 208, obtain additional data that characterizes user 101, one or more financial services accounts held by user 101, or the interactions between user 101 and the financial institution, such as, but not limited to, elements of reporting or credit-bureau data associated with user 101.

In some instances, executed qualification module 320 may perform additional operations that, based on the elements of alternative financial product data 318, identify one or more of the candidate financial products available to user 101 and appropriate to fund the purchase of the products or services from merchant 111, e.g., the $7,700 furniture purchase from “Barry's Furniture Shop.” Further, and for each of the identified candidate financial products, executed qualification module 320 may perform operations that apply corresponding ones of the internal qualification or underwriting criteria to the elements of transaction data 140A, profile data 140B, and account data 140C associated with user 101, and to the additional data associated with user 101 (e.g., the reporting or credit-bureau data described herein), and that generate a corresponding set candidate terms and conditions for each of the identified candidate financial products (e.g., to “pre-approve” user 101 for each of the identified candidate financial products). Based on the candidate terms and conditions, executed qualification module 320 may select one of the identified candidate financial products, and may package portions of alternative financial product data 318 that identify and characterize the selected financial product, and information identifying the term and conditions associated with the selected financial product, into corresponding portions of selected product data 322.

For example, the elements of alternate financial product data 318A may identify, and characterize, an available installment loan that is appropriate to fund the $7,700 real-time payment requested by “Barry's Furniture Shop.” In some instances, based on an application of the internal qualification or underwriting criteria associated with the instalment loan to the elements of transaction data 140A, profile data 140B, and account data 140C associated with user 101, and to the additional data associated with user 101, executed qualification module 320 may determine that user 101 is associated with a credit score above a threshold value and that checking account held by user 101 experiences a positive cashflow on a month-over-month basis (e.g., as specified by the associated internal qualification or underwriting criteria), and may establish terms and conditions for the installment loan that include, but are not limited to, a term of one year, a zero-percent interest rate, and a monthly payment of $641.67 during each month of the one-year term. In some instances, executed qualification module 320 may perform operations that package the elements of alternate financial product data 318A that identify and characterize the available installment loan, and information identifying the terms and conditions, into portions of selected product data 322.

Further, in some instances, executed qualification module 320 may also perform operations that compare the determined terms and conditions of the selected financial product (e.g., the one-year, interest-free installment loan described herein) against corresponding terms or conditions of the payment instrument selected by user 101 to fund the requested payment. For example, executed qualification module 320 may obtain the account number of the payment instrument selected by user 101 to fund the requested payment (e.g., the account number “XXXX-1234-5678-9012”), and based on portions of account data 140C associated with user 101, executed qualification module 320 may determine that the selected payment instrument represents a credit-card account associated with a 4% annual percentage rate (APR) and a current monthly payment of $1,275. Based on the terms and conditions of the selected payment instrument (e.g., the 4% APR and the current monthly payment of $1,275), executed qualification module 320 may determine that the one-year, interest-free installment loan represents a more mechanism for funding the $7,700 real-time payment requested by “Barry's Furniture Shop,” and based on the determination, executed qualification module 320 may perform operations that package the elements of alternate financial product data 318A that identify and characterize the available installment loan, and information identifying the terms and conditions, into the portions of selected product data 322.

In some instances, executed qualification module 320 may provide selected product data 322 as an input to an offer generation module 324 of executed analytical engine 148. As illustrated in FIG. 3, executed offer generation module 324 may package customer identifier 208 and selected product data 322, which includes the elements of alternate financial product data 318A that identify and characterize the available installment loan, and the information identifying the terms and conditions, into corresponding potions of offer data 326, which executed analytical engine 148 may provide as an input to notification engine 150. Upon execution by the one or more processors of FI computing system 130, executed notification engine 150 may perform any of the exemplary processes described herein to generate elements of notification data that identify, and characterize, the $7,700 real-time payment requested from user 101 by merchant 111, and the alternative financial product (e.g., the one-year, interest-free installment loan) available to fund the requested payment.

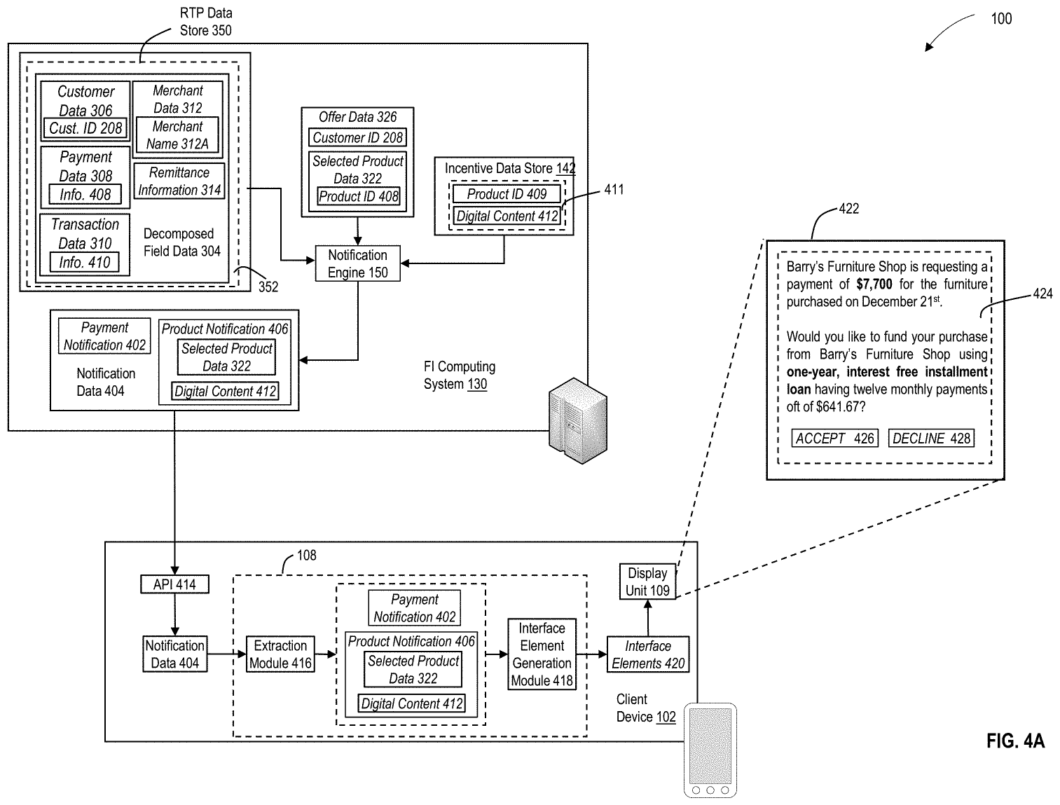

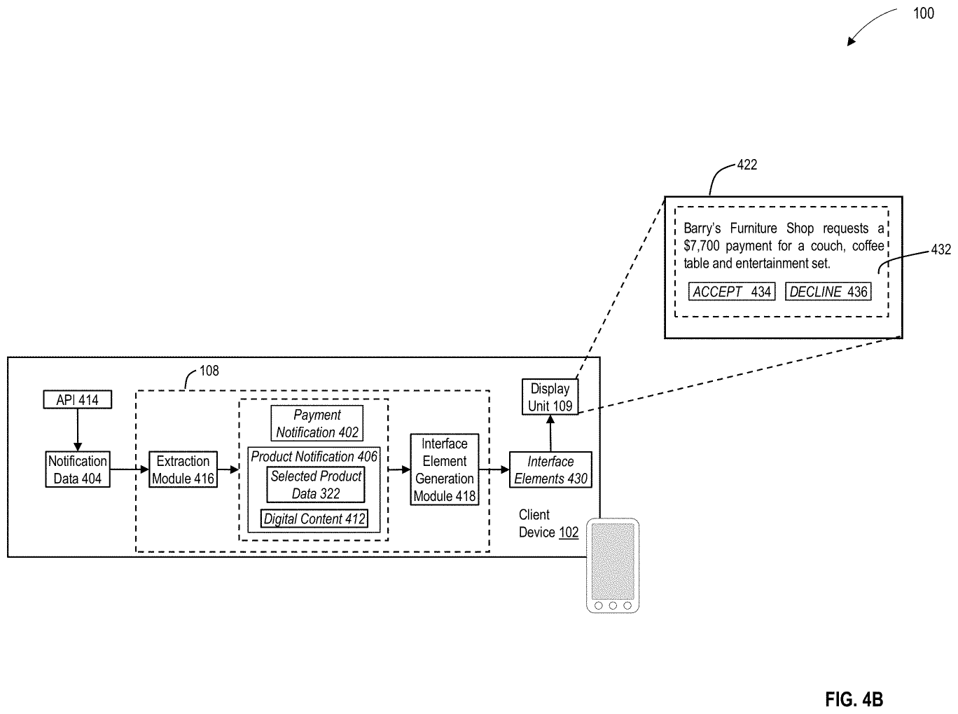

Referring to FIG. 4A, executed notification engine 150 may receive offer data 326, which includes customer identifier 208 and selected product data 322, and executed notification engine 150 may perform operations that, based on customer identifier 208, access elements 352 of RTP data store 350 and obtain decomposed field data 304. As described herein, decomposed field data 304 may include one or more elements of customer data 306, payment data 308, transaction data 310, merchant data 312, and remittance information 314 extracted from the structured or unstructured message fields of RFP message 226 and, as such, that identify and characterize $7,700 payment requested from user 101 by merchant 111 (e.g., Barry's Furniture Shop) to fund the purchase of the couch, coffee table, and entertainment set at 9:30 a.m. on Dec. 21, 2021.

In some instances, and based on portions of decomposed field data 304, executed notification engine 150 may perform operations that generate a payment notification 402 associated with the requested payment and that package payment notification 402 into a corresponding portion of notification data 404. For example, executed notification engine 150 may parse payment data 308 to obtain payment information 408 that identifies the requested payment date of Dec. 21, 2021 (e.g., obtained from message field 228 of RFP message 226) and the payment instrument selected by user 101 to fund the purchase transaction (e.g., the account number “XXXX-1234-5678-9012” obtained from message field 234 of RFP message 226). Executed notification engine 150 may also parse transaction data 310 to obtain information 410 that identifies the requested $7,700 payment amount and payment currency of US dollars (e.g., obtained from message fields 230 of RFP message 226), and may parse merchant data 312 to obtain a name 312A of merchant 111 (e.g., a merchant name “Barry's Furniture Shop” obtained from one or message fields 236 of RFP message 226). In some examples, executed notification engine 150 may perform operations that package all, or selected portion of, each of customer identifier 208, information 408 and 410, and merchant name 312A into corresponding portions of payment notification 402, which may be incorporated within notification data 404.

Further, executed notification engine 150 may parse offer data 326 and obtained the elements of selected product data 322, which includes the elements of alternate financial product data 318A that identify and characterize the available installment loan, and the information identifying the terms and conditions (e.g., the one-year term, the zero-percent interest rate, and the monthly payment of $641.67, etc.), and executed notification engine 150 may package each, or a selected portion, of the elements of selected product data 322 into a product notification 406. Further, executed notification engine 150 may also obtain, from the elements of selected product data 322, a product notification 406 associated with the available installment loan, and may parse the structured or unstructured data records of incentive data store 142 to identify one or more data records, such as data record 411, that includes or references product identifier 409. In some instances, data record 411 may include one or more elements of digital content 412 that, when rendered for presentation within a digital interface by client device 102, offers the available installment loan to user 101 in accordance with the terms and conditions, and prompts user 101 to accept, or alternatively, decline, the offer to fund the $7,700 real-time payment requested by “Barry's Furniture Store.” Executed notification engine 150 may obtain and package the elements of digital content 412 into product notification 406, which executed notification engine 150 may package into a corresponding portion of notification data 404. Executed notification engine 150 may perform additional operations that cause FI computing system 130 to transmit notification data 404 across network 120 to client device 102.

A programmatic interface associated with one or more application programs executed at client device 102, such as an application programming interface (API) 414 associated with mobile banking application 108, may receive notification data 404 and perform operations that cause client device 102 to executed mobile banking application 108 (e.g., through a generation of a programmatic command, etc.). Upon execution by the one or more processors of client device 102, executed mobile banking application 108 may receive notification data 404 from API 414, and a extraction module 416 of executed mobile banking application 108 may parse notification data 404 to obtain one or more of payment notification 402 and product notification 406, which includes selected product data 322 (e.g., identifying the available installment loan and the determined terms and conditions) and the elements of digital content 412.

In some instances, extraction module 416 may provide alternate financial product notification 414 as input to an interface element generation module 418 of executed mobile banking application 108, which may perform operations that generate and route interface elements 420 to display unit 109A. In some instances, when rendered for presentation within a corresponding notification interface 422 by display unit 109A, interface elements 430 provide a graphical representation 424 of the $7,700 payment requested by merchant 111 (e.g., “Barry's Furniture Shop”) for the furniture purchased on December 21st, and the one-year, interest-free installment loan available to fund the requested payment to user 101, e.g., within a single display screen or window, or across multiple display screens or windows, of notification interface 422. Further, interface elements 420 may, when presented within notification interface 422, prompt user 101 to accept, or reject, the offered alternate financial product (e.g., the one-year, interest-free installment loan) by providing further input to a respective one of an “ACCEPT” icon 426 and a “DECLINE” icon 428 presented within notification interface 422.

In some instances, user 101 may elect to accept the offered installment loan in accordance with the corresponding terms and conditions (e.g., the one-year term, the zero-percent interest rate, and the monthly payment of $641.67, etc.) and to fund the $7,700 payment requested by merchant 111 using funds provided by the installment loan. User 101 may provide input to client device 102 (e.g., via input unit 109B) that selects the “ACCEPT” icon 426. Based on the input, executed mobile banking application 108 may perform operations (not illustrated in FIG. 4A), that generate and transmit a response to notification data 404 that includes a product confirmation indicative of user 101's acceptance of the offered alternative financial product in accordance with the terms and conditions across FI computing system 130. In some instances, also not illustrated in FIG. 4A, FI computing system 130 may receive the response, and based on the confirmation data, perform operations that access selected product data 322 (e.g., as maintained within data repository 134), and that, in real-time and contemporaneously with the initiation of the purchase transaction, complete the internal qualification or underwriting processes for the accepted installment loan and issue the installment loan to user 101 in accordance with the determined terms and conditions, debit the $7,700 from an account associated with the issued installment loan, and credit the $7,700 to the financial services account associated with merchant 111 and specified within RFP message 226 (e.g., either directly, if the financial institution issues the financial services account associated with merchant 111, or based on additional ISO-20022-com pliant RTP messages exchanged with computing systems associated with other financial institution). FI computing system 130 may also perform operations that access RFP message 226 maintained within RFP queue 136, and delete RFP message 226 from RFP queue 136, e.g., based on the approval by user 101 and the real-time clearance and settlement of the approved payment.

Further, FI computing system 130 may also perform operations that transmit one or more messages to merchant computing system 110 that confirm the approval of the requested payment by user 101 and the real-time clearance and settlement of the approved payment, either directly across network 120 or through one or more of computing systems or devices 246 associated with participants in the RTP ecosystem (e.g., additional ISO-20022-compliant messages, etc.). Based on the one or more messages, merchant computing system 110 may perform operations that enable merchant 111 to execute the initiated purchase transaction and provision the purchased products or services, such as the couch, coffee table, and entertainment set, to user 101.

In other instances, user 101 may elect to define the offered installment loan and may provide additional input to client device 102 (e.g., via input unit 109B) that selects the “DECLINE” icon 428. Referring to FIG. 4B, and based on the additional input, executed extraction module 416 may route payment notification 402 to executed interface element generation module 418, which may perform operations that generate and route interface elements 430 to display unit 109A. When presented within notification interface 422 by display unit 109, interface elements 430 may provide a graphical representation 432 of payment notification 402 that prompts user 101 to approve or reject the $7,700 payment requested by Barry's Furniture Shop for the purchased couch, coffee table, and entertainment set, e.g., based on additional input provided to input device 109B of client device 102 that selects a respective one of an “APPROVE” icon 434 and a “REJECT” icon 436.

User 101 may, for example, elect to approve the $7,700 payment requested by merchant 111 for the purchase of the couch, coffee table, and entertainment set, and user 101 may provide input to client device 102 (e.g., via input unit 109B) that selected “APPROVE” icon 434. Based on the input, executed mobile banking application 108 may perform operations (not illustrated in FIG. 4B), that generate and transmit an additional response to notification data 404 that include a payment confirmation indicative of the approved payment across network 120 to FI computing system 130, which may perform operations that, in real-time, debit the $7,700 from an account held by user 101 and associated with the selected payment instrument, and that credit the $7,700 to the financial services account associated with merchant 111 and specified within RFP message 226 (e.g., either directly, if the financial institution issues the financial services account associated with merchant 111, or based on additional ISO-20022-compliant RTP messages exchanged with computing systems associated with other financial institution). FI computing system 130 may also perform operations that access RFP message 226 maintained within RFP queue 136, and delete RFP message 226 from RFP queue 136, e.g., based on the approval by user 101 and the real-time clearance and settlement of the approved payment.

Further, FI computing system 130 may also perform operations that transmit one or more messages to merchant computing system 110 that confirm the approval of the requested payment by user 101 and the real-time clearance and settlement of the approved payment, either directly across network 120 or through one or more of computing systems or devices 246 associated with participants in the RTP ecosystem (e.g., additional ISO-20022-compliant messages, etc.). Based on the one or more messages, merchant computing system 110 may perform operations that enable merchant 111 to execute the initiated purchase transaction and provision the purchased couch, coffee table, and entertainment set to user 101.

In other instances, and based on confirmation data indicating a rejection by user 101 of the requested payment (e.g., based on additional input selecting “REJECT” icon 436), FI computing system 130 may perform operations that delete RFP message 226 from RFP queue 136, and generate and transmit one or more messages to merchant computing system 110 indicative of the rejected payment, either directly across network 120 or through one or more of computing systems or devices 246 associated with participants in the RTP ecosystem (e.g., additional ISO-20022-compliant messages, etc.). Based on the indication of the rejection of the requested payment by user 101 (e.g., due to potential fraud, etc.), merchant computing system 110 may perform operations that enable merchant 111 to cancel the initiated purchase transaction in real-time and without delays and chargebacks characteristic of the transaction reconciliation, clearance, and settlement processes involving payment rails and transaction processing-messages.

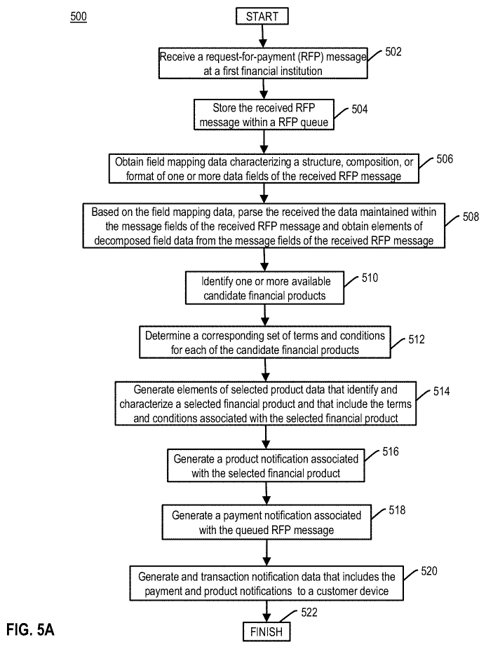

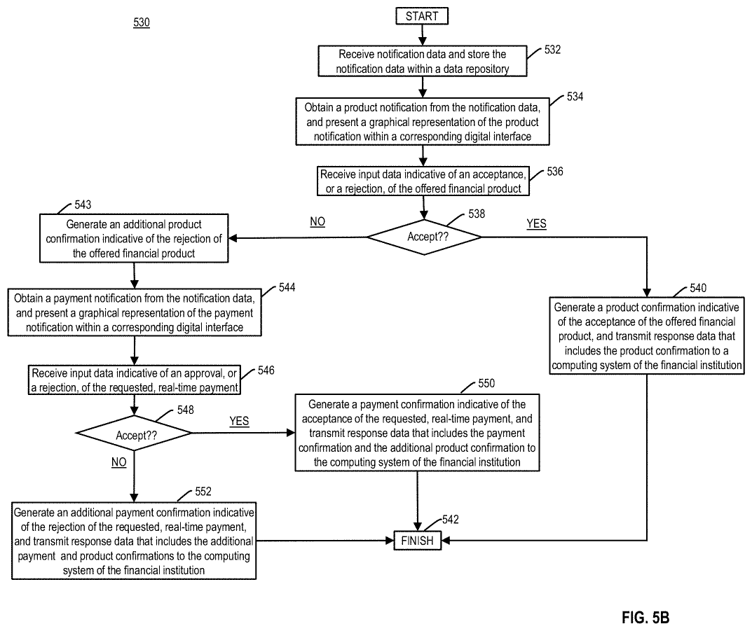

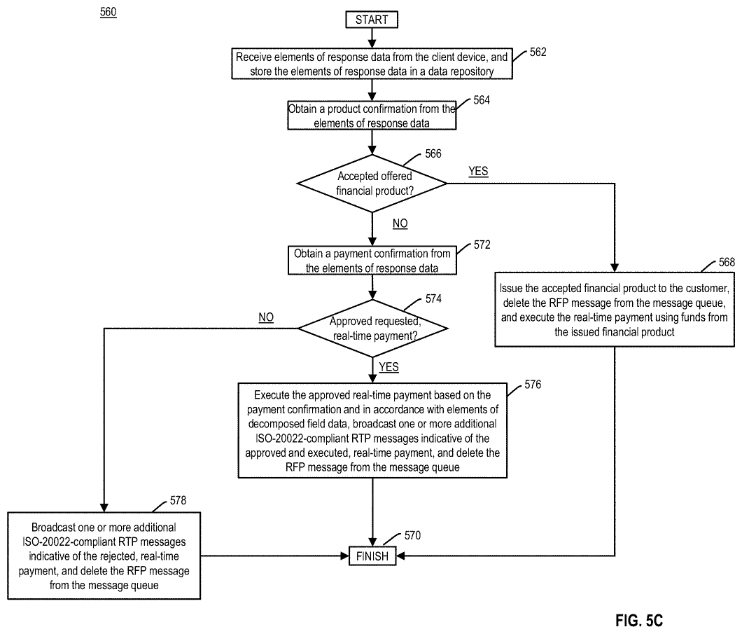

FIGS. 5A, 5B, and 5C are flowcharts of exemplary processes for provisioning targeted alternative product data to customer devices based on structured messaging data, in accordance with some exemplary embodiments. For example, one or more computing systems associated with a financial institution, such as FI computing system 130, may perform one or more of the steps of exemplary process 500, as described below in reference to FIG. 5A, and one or more of the steps of exemplary process 560, as described below in reference to FIG. 5C. Further, a computing device associated with, or operable by, user 101, such as client device 102, may perform one or more of the steps of exemplary process 530, as described below in reference to FIG. 5B.

Referring to FIG. 5A, FI computing system 130 may receive an RFP message having message fields structured in accordance with the ISO 20022 standard (e.g., in step 502 of FIG. 4), and may store the received RFP message within a message queue (e.g., in step 504 of FIG. 4). In some instances, FI computing system 130 may maintain the received RFP message within the message queue until the customer provides input accepting or rejecting the requested monthly payment, or alternatively, until an expiration of a corresponding period of temporal validity. As described herein, the received RFP message may characterize a purchase transaction initiated between a first counterparty (e.g., a merchant, such as merchant 111 associated with merchant computing system 110) and a second counterparty (e.g., a customer of the merchant, such as user 101 associated with client device 102), and the purchase transaction may involve, or be associated with one or more products or services provisioned by the first counterparty to the second counterparty. The RFP message may be generated by merchant computing system 110 using any of the exemplary processes described herein, and in some instances, FI computing system 130 may receive the RFP message directly from merchant computing system 110 across a corresponding communications network (e.g., communications network 120), or may receive the RFP message from via one or more intermediate computing systems, such as, but not limited to, as a computing system associated with the financial institution of the merchant or one or more computing systems of a clearinghouse associated with the RTP ecosystem. In other instances, the RFP message may be generated by one of intermediate computing systems, such as the computing system associated with the financial institution of the merchant or the one or more computing systems of the clearinghouse, based on elements of data characterizing the purchase transaction and generated by merchant computing system 110.

Further, and ass described herein, the received RFP message may include message fields consistent with the ISO 20022 standard for electronic data exchange between financial institutions, and each of the message fields may be populated with data structured and formatted in accordance with the ISO 20022 standard. By way of example, the received, ISO-20022-compliant RFP message may include, among other things, (i) message fields populated with data specifying a full name and postal address of user 101;(ii) message fields populated with data identifying a payment instrument selected by user 101 to fund the initiated purchase transaction; (iii) message fields populated with data specifying a name and postal address of the merchant; (iv) message fields populated with data identifying a financial services account held by the merchant and available to receive processed from the requested payment; and (v) message fields populated with one or more parameter values that characterize the purchase transaction, a requested payment method, and/or a requested payment date. The received, ISO-20022-compliant RFP message may also include structured or unstructured message fields that specify additional remittance information associated with the purchase transaction, and examples of the additional remittance information include, but are not limited to, information identifying a product or service involved in the purchase transaction, or a link to remittance data associated with the initiated transaction (e.g., a long-form URL or shortened to a PDF or HTML invoice, as described herein).

Responsive to the receipt of the RFP message, FI computing system 130 may access mapping data that identifies and characterizes each of the messages fields within the ISO-20022-compliant RFP message (e.g., in step 506 of FIG. 5A). Based on the mapping data, FI computing system 130 may perform any of the exemplary processes described herein to parse and analyze all or a selected subset of the message fields of the RFP message to extract, obtain, or derive discrete elements of data that identify and characterize user 101, merchant 11, the initiated purchase transaction, and the requested, real-time payment (e.g., in step 508 of FIG. 5A). FI computing system 130 may perform additional operations, described herein, that store the extracted, obtained, or derived data elements of decomposed field data (e.g., that identify and characterize user 101, merchant 11, the initiated purchase transaction, and the requested, real-time payment) within an accessible data repository, e.g., within an element of RTP data store 350.

In other instances, also in step 508, FI computing system 130 may perform any to the exemplary processes described herein to detect, within one or more of the message fields, a link to the remittance data associated with the requested monthly payment (e.g., a link to a PDF or HTML invoice or receipt that includes any of the information described herein that identifies the second financial institution requesting payment, the requested monthly payment, or the loan product). By way of example, the link may correspond to a long-form uniform resource locator (URL) into which certain elements of data may be embedded, such as, but not limited to, a unique identifier of the customer, and FI computing system 130 may perform operations, described herein, that parse the long URL to identify and extract the embedded data.

Additionally, or alternatively, FI computing system 130 may perform any of the exemplary processes described herein that, based on the detected link (e.g., the long-form URL described above, or a shortened URL, such as a tiny URL), programmatically access the remittance data associated with the processed link, e.g., as maintained at merchant computing system 110. The remittance data may include a PDF or HTML invoice or bill (e.g., formatted receipt data 240), and the FI computing system may perform operations that process the remittance data (e.g., through an application of an optical character recognition (OCR) process to the PDF invoice or bill, parsing code associated with the HTML invoice or bill, applying a screen-scraping technology to the invoice or bill) to extract the additional or alternate elements of the data that identifies and characterizes user 101, merchant 111, the initiated purchase transaction, and the requested, real-time payment. For instance, and based on the processed remittance data, the FI computing system may obtain elements of transaction data that, among other things, identifies a product or service involved in the initiated purchase transaction (e.g., a UPC, etc.).

In some instances, and based on the elements of decomposed field data associated with the received RFP message, and the real-time payment requested from user 101 by merchant 111, FI computing system 130 may perform any of the exemplary processes described herein to identify one or more candidate financial products that are available to user 101 (e.g., in step 510 of FIG. 5A), and to determine a corresponding set of terms and conditions for each of the candidate financial products (e.g., in step 512 of FIG. 5A). By way of example, and for each of the identified candidate financial products, FI computing system 130 may perform any of the exemplary processes described herein to apply corresponding internal qualification or underwriting criteria to elements of transaction data 140A, profile data 140B, and account data 140C associated with user 101, and to additional data associated with user 101 (e.g., the reporting or credit-bureau data described herein), and to generate a corresponding set candidate terms and conditions for each of the identified candidate financial products (e.g., to “pre-approve” user 101 for each of the identified candidate financial products).

Based on the candidate terms and conditions, FI computing system 130 may perform any of the exemplary processes described herein to select one of the identified candidate financial products, and to generate elements of selected product data that identify and characterize the selected financial product and that include the terms and conditions associated with the selected financial product (e.g., in step 514 of FIG. 5A). Further, FI computing system 30 may also perform any of the exemplary processes described herein to generate a product notification associated with the selected financial product (e.g., in step 516 of FIG. 5A). By way of example, the product notification may include, but is not limited to, information that identifies and characterizes the selected financial product (e.g., corresponding elements of selected product data, etc.) and digital content that, when presented on a digital interface generated by an application program executed at client device 102 (e.g., mobile banking application 108 of FIG. 1, etc.), prompt user 101 to provide input to client device 102 that accepts, or alternatively, declines, an offer to fund the requested, real-time payment using the selected financial product. Further, FI computing system 130 may perform any of the exemplary processes described herein to generate one or more elements of a payment notification associated with the queued RFP message based on all, or a selected portion, of the decomposed field data (e.g., in step 518 of FIG. 5A).

By way of example, and as described herein, the payment notification may be associated with the requested, real-time payment, and the payment notification may include, among other things, the full name of user 101, the requested payment amount and payment date, information identifying a customer account that funds the requested payment, and information identifying merchant 111. Further, the payment notification may also include digital content that, when presented on a digital interface generated by an application program executed at client device 102 (e.g., mobile banking application 108 of FIG. 1, etc.), prompt user 101 to provide input to client device 102 that approves, or alternatively, declines, the real-time payment requested from user 101 by merchant 111.

FI computing system 130 may perform any of the exemplary processes described herein to package the generated payment and product notifications into corresponding portions of notification data, and to transmit the notification data across network 120 to client device 102 (e.g., in step 520 of FIG. 4A). In some instances, client device 102 may receive the elements of notification data, and an application program executed by the one or more processors of client device 102 (e.g., executed mobile banking application 108) may perform any of the exemplary processes described herein to present, within a corresponding digital interface, a graphical representation of the product notification that prompts user 101 to accept, or alternatively, decline, the offer to fund the requested, real-time payment using the selected financial product, and responsive to input that declines the offer, to approve, or reject, the real-time payment requested by merchant 111. Exemplary process 500 may be complete in step 522.

Referring to FIG. 5B, client device 102 may perform any of the exemplary processes described herein to receive the elements of notification data from FI computing system 130, and store the elements of notification data within a portion of a tangible, non-transitory memory accessible to client device 102 (e.g., in step 532 of FIG. 5B). Client device 102 may also perform any of the exemplary processes described herein to obtain the product notification from the received elements of notification data, and generate, and render for presentation within a corresponding digital interface, a graphical representation of portions of the product notification that prompts user 101 to accept, or alternatively, decline, the offer to fund the requested, real-time payment using the selected financial product (e.g., in step 534 of FIG. 5B). Further, client device 102 may also receive, via input unit 109B, elements of user input indicative of an accepts, or alternatively, a declines, the offer to fund the requested, real-time payment using the selected financial product (e.g., in step 536 of FIG. 5B), and based on the elements of user input, client device 102 may determine whether user 101 accepted, or declined, the offer (e.g., in step 538 of FIG. 5B). If, for example, client device 102 were to determine that user 101 accepted the offer to fund the requested, real-time payment using the selected financial product (e.g., step 538; YES), client device 102 may perform any of the exemplary processes described herein to process the elements of input data and generate a product confirmation indicative of the acceptance, by user 101, of the offer to fund the requested, real-time payment using the selected financial product, and to transmit a response to the notification data that includes the product confirmation to FI computing system 130 (e.g., in step 540 of FIG. 5B). Exemplary process 530 may be complete in step 542.

Alternatively, if client device 102 were to determine that user 101 declined the offer to fund the requested, real-time payment using the selected financial product (e.g., step 538; NO), client device 102 may perform any of the exemplary processes described herein to generate an additional product confirmation indicating the rejection of the offer by user 101 (e.g., in step 543 of FIG. 5B), and to obtain the payment notification from the received elements of notification data, and generate, and render for presentation within a corresponding digital interface, a graphical representation of the payment notification that prompts user 101 to approve, or alternatively, reject, the real-time payment requested from user 101 by merchant 111 (e.g., in step 544 of FIG. 5B). Client device 102 may receive, via input unit 109B, elements of user input indicative of an approval, or alternatively, a rejection, of the requested, real-time payment by user 101 (e.g., in step 546 of FIG. 5B), and based on the elements of user input, client device 102 may determine whether user 101 approved, or rejected, the requested real-time payment (e.g., in step 548 of FIG. 5B). If, for example, client device 102 were to determine that user 101 approved the requested, real-time payment (e.g., step 548; YES), client device 102 may perform any of the exemplary processes described herein to process the elements of input data and generate a payment confirmation indicative of the approval, by user 101, of the requested real-time payment, and to transmit a response to the notification data that includes the additional product confirmation and the payment confirmation to FI computing system 130 (e.g., in step 550 of FIG. 5B). Exemplary process 530 may then be complete in step 542.

Alternatively, if client device 102 were to determine that user 101 rejected the requested, real-time payment (e.g., step 548; NO), client device 102 may perform any of the exemplary processes described herein to generate an additional payment confirmation indicating the rejection of the requested, real-time payment by user 101 and to generate elements of additional response data that include the additional product and payment confirmations in conjunction with the identifier of user 101 and/or merchant 111 (e.g., in step 552 of FIG. 5B). Client device 102 may also transmit the elements of additional response data across network 120 to FI computing system 130 (e.g., also in step 552 of FIG. 5B). Exemplary process 530 is then complete in step 542.

Referring to FIG. 5C, FI computing system 130 may receive the elements of response data from client device 102, and may store the received elements of response data within one or more tangible, non-transitory memories accessible to FI computing system 130, such as in conjunction with the elements of decomposed field data within data repository 134 (e.g., in step 562 of FIG. 5C). FI computing system 130 may also perform any of the exemplary processes described herein to obtain, from the elements of response data, the product confirmation indicative of the acceptance, or alternatively, the rejection, the offer to fund the requested, real-time payment using the selected financial product (e.g., in step 564 of FIG. 5C), and to process the product confirmation and determine whether user 101 accepted, or declined, the offer (e.g., in step 566 of FIG. 4C).

If, for example, FI computing system 130 were to determine that user 101 accepted the offer to fund the requested, real-time payment using the selected financial product (e.g., step 566; YES), FI computing system 130 may perform any of the exemplary processes described herein to complete a qualification or underwriting process and issue the selected financial product to the customer (e.g., in step 568 of FIG. 5C). Fl computing system 130 may perform any of the exemplary processes described herein, in step 568, to execute the real-time payment requested by merchant 111 using funds drawn from the now-issued financial product, and to delete the RFP message from the message queue. Exemplary process 560 may then be complete in step 570.

Alternatively, if FI computing system 130 were to determine that user 101 decline the offer to fund the requested, real-time payment using the selected financial product (e.g., step 566; NO), FI computing system 130 may perform any of the exemplary processes described herein to obtain, from the elements of response data, the payment confirmation indicative of the approval, or alternatively, the rejection, of the real-time payment request from user 101 by merchant 111 (e.g., in step 572 of FIG. 5C), and to process the payment confirmation and to determine whether user 101 approved, or rejected, the real-time payment (e.g., in step 574 of FIG. 5C).

If, for example, FI computing system 130 were to determine that user 101 approved the requested, real-time payment (e.g., step 574; YES), FI computing system 130 may perform any of the exemplary processes described herein to execute the now-approved real-time payment based on the payment confirmation and in accordance with the elements of decomposed field data, and that delete the RFP message from the RFP message queue (e.g., in step 576 of FIG. 5C). Exemplary process 560 may then be complete in step 570.

Alternatively, if FI computing system 130 were to determine that user 101 rejected the requested, real-time payment (e.g., step 574; NO), FI computing system 130 may perform any of the exemplary processes described herein to broadcast one or more additional ISO-20022-compliant RTP messages that confirm the rejection of the requested, real-time payment by user 101, and that delete the RFP message from the RFP message queue (e.g., in step 578 of FIG. 4C). Exemplary process 560 may be complete in step 570.

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including merchant application 106, mobile banking application 108, decomposition engine 146, analytical engine 148, notification engine 150, RTP engine 216, application programming interfaces (APIs) 214, 302, and 414, remittance analysis engine 354, alternate product determination module 316, qualification module 320, offer generation module 324, extraction module 416, and interface element generation module 418, can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, such as user 101, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. An apparatus comprising:
a communications interface;
a memory storing instructions; and
at least one processor coupled to the communications interface and to the memory, the at least one processor being configured to execute the instructions to:
receive, via the communications interface, a message associated with an exchange of data involving a first counterparty and a second counterparty, the message comprising elements of message data disposed within corresponding message fields, and the message data characterizing a real-time payment requested from the second counterparty by the first counterparty;
determine that a product is available to the second counterparty based on one or more of the elements of the message data, the product being associated with a first parameter value that is consistent with at least one second parameter value of the data exchange; and
transmit, via the communications interface, first notification data to a device operable by the second counterparty, the first notification data comprising product data characterizing the product, and the first notification data causing an application program executed at the device to present at least a portion of the product data within a digital interface.

2. The apparatus of claim 1, wherein the product data comprises a product identifier and the first parameter value, and the first notification data further causes the executed application program to present the product identifier and the first parameter value within the digital interface.

3. The apparatus of claim 1, wherein:
the first notification data is associated with an offer to provision the product to the second counterparty in accordance with the first parameter value; and
the at least one processor is further configured to execute the instructions to receive, via the communications interface, a response to the first notification data from the device.

4. The apparatus of claim 3, wherein the at least one processor is further configured to execute the instructions to:
determine that the response is associated with an acceptance of the offer to provision the product to the second counterparty; and
perform operations that provision the product to the second counterparty in accordance with the first parameter value.

5. The apparatus of claim 4, wherein the at least one processor is further configured to execute the instructions to:
based on the provisioning of the product to the second counterparty, generate an additional message associated with the real-time payment, the additional message comprising message fields structured in accordance with a standardized data-exchange protocol, and the message fields comprising information identifying the provisioned product; and
transmit the additional message to a computing system associated with the first counterparty via the communications interface.

6. The apparatus of claim 3, wherein the at least one processor is further configured to execute the instructions to:
determine that the response is associated with a rejection of the offer to provision the product to the second counterparty; and
generate second notification data that includes information characterizing the real-time payment, and transmit the second notification data to the device via the communications interface, the second notification data causing the executed application program to present at least a portion of the information within the digital interface.

7. The apparatus of claim 3, wherein the at least one processor is further configured to execute the instructions to:
obtain a qualification criterion associated with the product from the memory;
determine the first parameter value based on the qualification criterion and on one or more of the elements of the message data.

8. The apparatus of claim 1, wherein the at least one processor is further configured to execute the instructions to:
obtain, from the memory, mapping data associated with the message fields of the message;
perform operations that obtain the elements of the message data from corresponding ones of the message fields based on the mapping data; and
store the elements of the message data within the memory, the elements of the message data comprising a first identifier of the first counterparty, a second identifier of the second counterparty, and the at least one second parameter value characterizing the data exchange.

9. The apparatus of claim 8, wherein:
the message comprises a request-for-payment message, the message fields of the request-for-payment message being structured in accordance with a standardized data-exchange protocol; and
elements of the mapping data identify corresponding ones of the elements of the message data and corresponding ones of the message fields.

10. The apparatus of claim 8, wherein the at least one processor is further configured to execute the instructions to:
obtain, based on the mapping data, remittance information associated with the data exchange from one or more of the message fields, the remittance information comprising a uniform resource locator associated with one or more elements of formatted data maintained by a computing system;
process the one or more elements of formatted data; and
obtain at least one of the first identifier, the second identifier, or the at least one second parameter value characterizing the data exchange from the processed elements of formatted data.

11. A computer-implemented method, comprising:
receiving, using at least one processor, a message associated with an exchange of data involving a first counterparty and a second counterparty, the message comprising elements of message data disposed within corresponding message fields, and the message data characterizing a real-time payment requested from the second counterparty by the first counterparty;
determining, using the at least one processor, that a product is available to the second counterparty based on one or more of the elements of the message data, the product being associated with a first parameter value that is consistent with at least one second parameter value of the data exchange; and
transmitting, using the at least one processor, first notification data to a device operable by the second counterparty, the first notification data comprising product data characterizing the product, and the first notification data causing an application program executed at the device to present at least a portion of the product data within a digital interface.

12. The computer-implemented method of claim 11, wherein the product data comprises a product identifier and the first parameter value, and the first notification data further causes the executed application program to present the product identifier and the first parameter value within the digital interface.

13. The computer-implemented method of claim 11, wherein:
the first notification data is associated with an offer to provision the product to the second counterparty in accordance with the first parameter value; and
further comprising receiving, using the at least one processor, a response to the first notification data from the device.

14. The computer-implemented method of claim 13, further comprising:
determining, using the at least one processor, that the response is associated with an acceptance of the offer to provision the product to the second counterparty; and
performing operations, using the at least one processor, that provision the product to the second counterparty in accordance with the first parameter value.

15. The computer-implemented method of claim 14, further comprising:
based on the provisioning of the product to the second counterparty, generating, using the at least one processor, an additional message associated with the real-time payment, the additional message comprising message fields structured in accordance with a standardized data-exchange protocol, and the message fields comprising information identifying the provisioned product; and
transmitting, using the at least one processor, the additional message to a computing system associated with the first counterparty.

16. The computer-implemented method of claim 13, further comprising:
determining, using the at least one processor, that the response is associated with a rejection of the offer to provision the product to the second counterparty; and
using the at least one processor, generating second notification additional data that includes data characterizing the real-time payment, and transmitting the second notification data to the device, the second notification data causing the executed application program to present at least a portion of the additional data within the digital interface.

17. The computer-implemented method of claim 13, further comprising:
obtaining, using the at least one processor, a qualification criterion associated with the product;
determining, using the at least one processor, the first parameter value based on the qualification criterion and on one or more of the elements of the message data.

18. The computer-implemented method of claim 11, further comprising:
obtaining, using the at least one processor, from a data repository, mapping data associated with the message fields of the message;
performing operations, using the at least one processor, that obtain the elements of the message data from corresponding ones of the message fields based on the mapping data; and
storing the elements of the message data within the data repository using the at least one processor, the elements of the message data comprising a first identifier of the first counterparty, a second identifier of the second counterparty, and the at least one second parameter value characterizing the data exchange.

19. The computer-implemented method of claim 18, wherein:
the message comprises a request-for-payment message, the message fields of the request-for-payment message being structured in accordance with a standardized data-exchange protocol; and
elements of the mapping data identify corresponding ones of the elements of the message data and corresponding ones of the message fields.

20. A tangible, non-transitory computer-readable medium storing instructions that, when executed by at least one processor, cause the at least one processor to perform a method, comprising:
receiving a message associated with an exchange of data involving a first counterparty and a second counterparty, the message comprising elements of message data disposed within corresponding message fields, and the message data characterizing a real-time payment requested from the second counterparty by the first counterparty;
determining that a product is available to the second counterparty based on one or more of the elements of the message data, the product being associated with a first parameter value that is consistent with at least one second parameter value of the data exchange; and
transmitting first notification data to a device operable by the second counterparty, the first notification data comprising product data characterizing the product, and the first notification data causing an application program executed at the device to present at least a portion of the product data within a digital interface.
